(19) United States
(12) Patent Application Publication
(10) Pub. No.: US 2022/0343573 A1
(43) Pub. Date: Oct. 27, 2022

(54) IMAGE PROCESSING APPARATUS, IMAGE PROCESSING METHOD, AND PROGRAM

(71) Applicant: SONY GROUP CORPORATION, TOKYO (JP)

(72) Inventors: TAKESHI HARADA, TOKYO (JP); NOBUYOSHI SHIRAI, TOKYO (JP); HIROYOSHI FUJII, TOKYO (JP)

(21) Appl. No.: 17/753,910

(22) PCT Filed: Sep. 9, 2020
(86) PCT No.: PCT/JP2020/034177

§ 371 Date: Mar. 18, 2022

(30) Foreign Application Priority Data
Sep. 27, 2019 (JP) 2019-177627

(51) Int. Cl. G06T 11/60

(52) U.S. Cl. CPC G06T 11/60; G06T 2200/24

(57) ABSTRACT

An image processing apparatus includes: a moving object extraction unit configured to generate, regarding a moving object extraction target image, an extracted image obtained by extracting an image of a moving object in an area other than a mask area set as an area from which an image to be used for synthesis is not extracted; and an image synthesis unit configured to perform processing of synthesizing the extracted image with another image.

### CROSS REFERENCE TO RELATED APPLICATIONS

This application claims the benefit of Japanese Priority Patent Application JP 2019-177627 filed on Sep. 27, 2019, the entire contents of which are incorporated herein by reference.

### TECHNICAL FIELD

The present technology relates to an image processing apparatus, an image processing method, and a program, and more particularly to a technical field regarding processing of synthesizing an extracted image of a moving object with another image.

### BACKGROUND ART

Various technologies have been proposed for image synthesis processing of synthesizing a plurality of images. For example, PTL 1 below discloses a technology regarding subject extraction and synthesis processing with a background image.

### CITATION LIST

### Patent Literature

[PTL 1]

JP 2013-3990A

### SUMMARY

### Technical Problem

In a case of a device having a function to extract a moving object from a moving image and synthesize an extracted image with another image, the device detects the moving object existing in a frame of the image and extracts a pixel range of a subject as the moving object. In this case, the device may extract an extra item although the device desirably extracts only a specific subject in the image.

For example, assumed is a case of imaging a performer who is doing a performance or is making a presentation in a room and synthesizing the captured image with another image. In this case, only the performer as a moving object is desirably extracted from the captured image. Since only the performer moves at the imaging site, only an image of the performer is usually extracted.

However, for example, in a case where an image of some sort of moving object is reflected on a window glass behind the performer, for example, in a case where a curtain moves, or the like, the image or the curtain is extracted as a moving object from the captured image. Then, such unnecessary moving object is also synthesized in a synthesized image, and a desired image is not able to be created.

Meanwhile, the above-described curtain or the like can be excluded by recognizing all of objects appearing in an image and extracting only a specific subject such as a person, for example. However, such processing increases the burden of the process and can be executed by only a device with high processing capability.

Therefore, the present disclosure proposes a technology for preventing an unnecessary moving object from being extracted as an image to be synthesized by simpler processing.

### Solution to Problem

An image processing apparatus according to the present technology includes a moving object extraction unit configured to generate, regarding a moving object extraction target image, an extracted image obtained by extracting an image of a moving object in an area other than a mask area set as an area from which an image to be used for synthesis is not extracted, and an image synthesis unit configured to perform processing of synthesizing the extracted image with another image.

The moving object extraction target image is target image data for which moving object extraction processing is performed. For example, an image captured and input by a camera is set as the moving object extraction target image. Regarding the image, moving object detection is performed, and an image of a subject determined as a moving object such as a person is extracted. The extracted image of the moving object is synthesized with another image. In this case, in the moving object extraction target image, setting of the mask area in which an image as a moving object image to be used for synthesis is not extracted is made possible.

In the above-described image processing apparatus according to the present technology, it is conceivable that the moving object extraction unit extracts an image of an absolute extraction area set as an area from which an image to be used for synthesis is extracted, from the moving object extraction target image, regardless of whether or not an object is a moving object, and generates the extracted image.

For example, there are cases where an image captured and input by a camera is desired to be added to a synthesized image, regardless of whether or not an object is a moving object. For example, an area where such an object exists on the image is set as the absolute extraction area, and is caused to be extracted as a target for synthesis processing regardless of whether or not an image of the subject is a moving object.

In the above-described image processing apparatus according to the present technology, it is conceivable to include a user interface control unit configured to control a setting of a position, a shape, or a size of the mask area on a screen. For example, a user can determine the position of the mask area or can determine the shape or size of the mask area by an operation on a screen on which the moving object extraction target image and the another image are displayed.

In the above-described image processing apparatus according to the present technology, it is conceivable that the user interface control unit controls the setting of a position, a shape, or a size of the mask area on a screen on which a synthesized image of the moving object extraction target image and the another image is displayed.

For example, the user can determine the position of the mask area or can determine the shape or size of the mask area by an operation on a screen on which the synthesized image is displayed for preview.

In the above-described image processing apparatus according to the present technology, it is conceivable to include a user interface control unit configured to control a setting of a position, a shape, or a size of the absolute extraction area on a screen.

For example, the user can determine the position of the absolute extraction area or can determine the shape or size of the absolute extraction area by an operation on the screen on which the moving object extraction target image and the another image are displayed.

In the above-described image processing apparatus according to the present technology, it is conceivable that the user interface control unit controls the setting of a position, a shape, or a size of the absolute extraction area on a screen on which a synthesized image of the moving object extraction target image and the another image is displayed.

For example, the user can determine the position of the absolute extraction area or can determine the shape or size of the absolute extraction area by an operation on the screen on which the synthesized image is displayed for preview.

In the above-described image processing apparatus according to the present technology, it is conceivable that the user interface control unit varies an image synthesis ratio according to an operation on the synthesized image of the moving object extraction target image and the another image.

In the synthesized image displayed for setting the mask area, the synthesis ratio of the moving object extraction target image can be varied by the user's operation with respect to the another image, for example. For example, a display state in which the moving object extraction target image clearly appears, lightly appears, or disappears can be varied.

Of course, in the synthesized image displayed for setting the absolute extraction area, the synthesis ratio may be able to be similarly varied.

In the above-described image processing apparatus according to the present technology, it is conceivable to include a user interface control unit configured to control a setting of a position, a shape, or a size of one or both of the mask area and the absolute extraction area on a screen, and that the user interface control unit makes a display indicating the mask area on the screen and a display indicating the absolute extraction area on the screen be in different display modes.

Ranges of the mask area and the absolute extraction area are presented by frame display or translucent area display on the screen, for example. At this time, the display mode for the display representing each area is made different. For example, the color of the frame range, the type of a frame line (solid line, broken line, wavy line, double line, thick line, thin line, or the like), or the color, brightness, transparency, or the like of the area is made different.

In the above-described image processing apparatus according to the present technology, it is conceivable to include a user interface control unit configured to control a setting of a position, a shape, or a size of one or both of the mask area and the absolute extraction area on a screen, and that the user interface control unit performs processing of limiting a setting operation so as not to cause an overlap of the mask area and the absolute extraction area.

For example, the mask area and the absolute extraction area are made arbitrarily settable by being displayed with the mask frame and the absolute extraction frame on the screen. However, such an operation is limited in a case where an overlap occurs by the operation.

In the above-described image processing apparatus according to the present technology, it is conceivable that the user interface control unit controls a setting of the another image. That is, an environment for selecting, for example, a background image as the another image to be synthesized with the moving object extraction target image is provided.

In the above-described image processing apparatus according to the present technology, it is conceivable that the image synthesis unit is able to output a synthesized image of the extracted image and the another image and also output a left-right flipped image of the synthesized image.

For example, the image synthesis unit outputs the left-right flipped image as an output of another system while outputting image data as the synthesized image.

In the above-described image processing apparatus according to the present technology, it is conceivable that the image synthesis unit is able to output a synthesized image of the extracted image and the another image and also output the extracted image.

For example, the image synthesis unit outputs the extracted image as an output of another system while outputting image data as the synthesized image.

In the above-described image processing apparatus according to the present technology, it is conceivable to include a user interface control unit configured to control an output of a left-right flipped image of the synthesized image.

The user can select whether or not to cause the image processing apparatus to execute output of the left-right flipped image.

In the above-described image processing apparatus according to the present technology, it is conceivable to include a user interface control unit configured to control an output of the extracted image.

The user can select whether or not to cause the image processing apparatus to execute output of only the extracted image generated in the moving object extraction unit.

In the above-described image processing apparatus according to the present technology, it is conceivable that the moving object extraction target image is a captured image by a camera.

That is, regarding the captured image by the camera, a moving object is extracted, and the moving object is reflected in the synthesized image.

In the above-described image processing apparatus according to the present technology, it is conceivable that one of the other images is a background image.

That is, the background image is prepared and synthesized with the moving object extraction target image.

In the above-described image processing apparatus according to the present technology, it is conceivable that images of a plurality of systems are able to be input, the moving object extraction target image is a captured image by a camera input in one system, and one of the other images is an input image input in another system. As another input system, another image used for description of the performer, for example, can be made synthesizable.

In the above-described image processing apparatus according to the present technology, it is conceivable that one of the other images is a logo image.

That is, the logo image is prepared and synthesized with the moving object extraction target image.

An image processing method according to the present technology includes generating, regarding a moving object extraction target image, an extracted image obtained by extracting an image of a moving object in an area other than a mask area set as an area from which an image to be used for synthesis is not extracted, and performing processing of synthesizing the extracted image with another image.

As a result, a moving object in the mask area is excluded from an extraction target for synthesis.

The program according to the present technology is a program for causing such an image processing apparatus to execute such an image processing method. For example, the program causes an arithmetic processing unit as a control unit built in the image processing apparatus to execute the image processing method. As a result, the processing of the present technology can be executed by various image processing apparatuses.

### BRIEF DESCRIPTION OF DRAWINGS

FIG. 1 is an explanatory diagram of a synthesized image according to an embodiment of the present technology.

FIG. 2 is an explanatory diagram of a layer configuration of a synthesized image according to the embodiment.

FIG. 3 is a block diagram of an image processing apparatus according to the embodiment.

FIG. 4 is an explanatory diagram of a functional configuration of the image processing apparatus according to the embodiment.

FIG. 5 is a flowchart of setting processing according to the embodiment.

FIG. 6 is a flowchart of mask area setting processing according to the embodiment.

FIG. 7 is a flowchart of absolute extraction area setting processing according to the embodiment.

FIG. 8 is an explanatory diagram of a state in which a background image is displayed on a setting screen according to the embodiment.

FIG. 9 is an explanatory diagram of a state in which another background image is displayed on the setting screen according to the embodiment.

FIG. 10 is an explanatory diagram of a state in which a screen area is disposed on the setting screen according to the embodiment.

FIG. 11 is an explanatory diagram of a camera image according to the embodiment.

FIG. 12 is an explanatory diagram of area setting performed on the setting screen according to the embodiment.

FIG. 13 is an explanatory diagram of when a transmittance operation is performed on the setting screen according to the embodiment.

FIG. 14 is an explanatory diagram of when a transmittance operation is performed on the setting screen according to the embodiment.

FIG. 15 is an explanatory diagram of a mask area and an absolute extraction area set on the setting screen according to the embodiment.

FIG. 16 is a flowchart of synthesis processing of the embodiment.

FIGS. 17A to 17F are explanatory diagrams of a key image generation process of the synthesis process according to the embodiment.

FIG. 18 is an explanatory diagram of an output monitor screen according to the embodiment.

FIG. 19 is an explanatory diagram of a left-right flipped image of the embodiment.

FIG. 20 is an explanatory diagram of display of only a camera image according to the embodiment.

FIG. 21 is a flowchart of a case in which object recognition is performed by mask processing in the embodiment.

FIG. 22 is a flowchart of a case in which object recognition is performed by absolute extraction area image extraction processing in the embodiment.

### DESCRIPTION OF EMBODIMENTS

Hereinafter, an embodiment will be described in the following order.

<1. Explanation of Synthesized Image>

<2. Configuration of Image Processing Apparatus>

<3. Setting Processing and UI>

<4. Synthesis Processing and UI>

<5. Processing Example in Case of Performing Object Recognition>

<6. Conclusion and Modifications>

<1. Explanation of Synthesized Image>

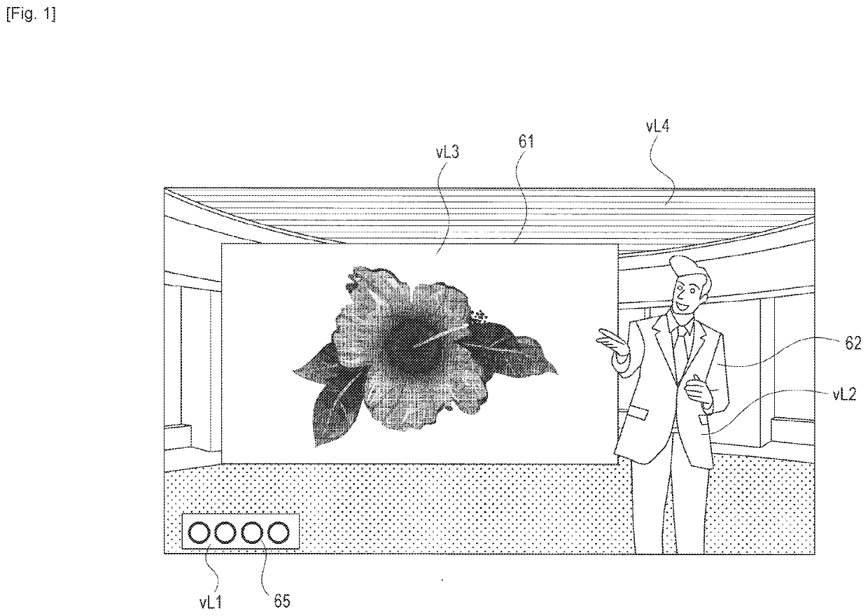

FIG. 1 illustrates an example of a synthesized image produced by the technology of the present disclosure.

This synthesized image is basically obtained by synthesizing an image of a performer 62 that is being captured by a camera, for example, after setting a certain image as a background.

Moreover, in this case, a screen area 61 is set in the image, and an image of a different system from the image including the performer 62 is displayed in the screen area 61. Here, a state in which a flower image is synthesized with the screen area 61 is illustrated.

As a result, there is created a synthesized image illustrating a scene as if the performer 62 makes a presentation while using an image (screen image) displayed in the screen area 61 at a place set by the background.

Furthermore, an image of a logo 65 is synthesized and displayed in the image.

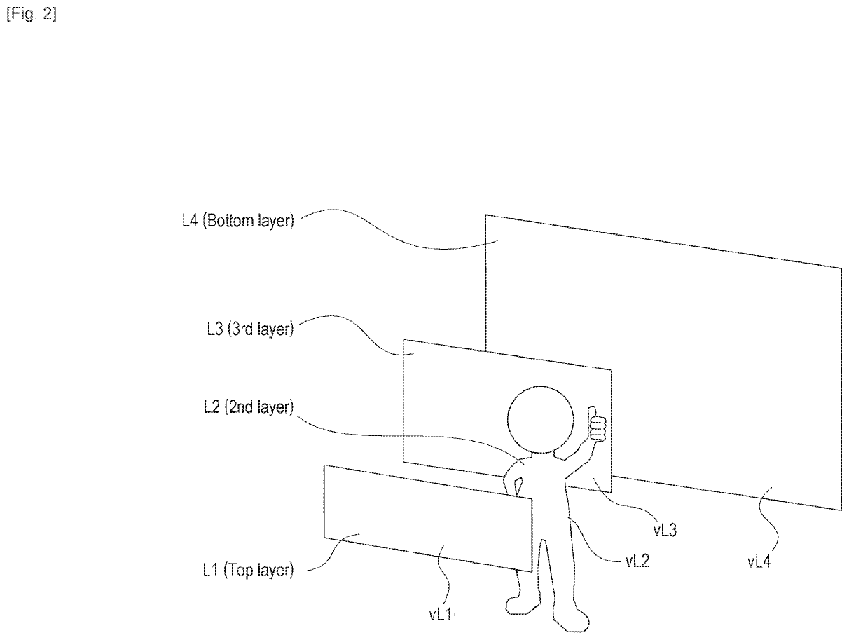

FIG. 2 illustrates a layer configuration of such a synthesized image.

In this example, the synthesized image has a four-layer configuration including a top layer L1, a second layer L2, a third layer L3, and a bottom layer L4.

Note that the synthesized image according to the present technology does not necessarily have a four-layer configuration, and the synthesized image may have at least a two-layer configuration. Of course, a three-layer configuration or a layer configuration having five or more layers may be adopted.

A top layer image vL1 is displayed on the top layer L1 on a foremost side. In the example in FIG. 1, the image of the logo 65 (hereinafter referred to as “logo image”) is the top layer image vL1.

A second layer image vL2 is displayed on the second layer L2 in FIG. 2. In the example in FIG. 1, the image of the performer 62 is the second layer image vL2. For example, moving object extraction processing is performed for an image in which the performer is captured by the camera, so that the image of the performer 62 is extracted and reflected in the synthesized image.

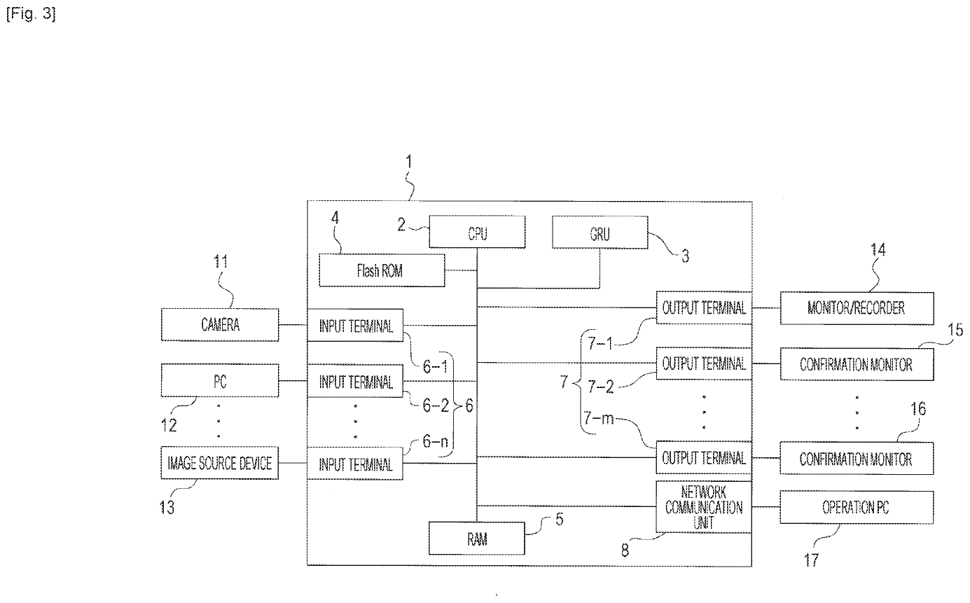

Note that the image captured by the camera is also referred to as a “camera image” for the sake of description. This “camera image” particularly refers to an image input to an image processing apparatus 1 of the present embodiment, which is captured by a camera 11 illustrated in FIG. 3 to be described below.

An image extracted by the moving object extraction processing for the camera image is written as an “extracted image vE” and is distinguished from the camera image before the extraction processing.

A third layer image vL3 is displayed on the third layer L3 in FIG. 2. The third layer image vL3 is applied to the screen area 61 set at a predetermined position as illustrated in FIG. 1. The image displayed in the screen area 61 is referred to as the “screen image”.

The screen image may be a moving image, a still image, or an image such as a pseudo moving image or a slide show.

The content of the screen image may be adapted to the purpose of moving image content created as a synthesized image, for example. A presentation image, a lecture image, a product description image, an image for various types of explanation, or the like is assumed as the screen image. However, the content is not particularly limited.

A bottom layer image vL4 is displayed on the bottom layer L4. As the bottom layer image vL4, an image serving as a background (hereinafter “background image”) is used. For example, in the example in FIG. 1, a background image like a scene of a news studio is used. Other than the above image, an image representing a place such as a classroom, a library, a laboratory, a beach, a park, or a downtown is assumed as the background. Alternatively, a background image that is not a normal natural space, such as a monochrome background like a blue background, or a geometric pattern, may be used.

A still image is assumed as the background image. However, a moving image, a pseudo moving image, or the like may be used.

With the layer configuration, the synthesized image in which the performer 62 makes a presentation using the screen image in front of a certain background, and the logo 65 of a company, product, organizer, or the like is displayed on the front surface is produced.

<2. Configuration of Image Processing Apparatus>

FIG. 3 illustrates a configuration of the image processing apparatus 1 according to the present embodiment for producing a synthesized image as described above. FIG. 3 illustrates examples of peripheral devices to be connected together with the image processing apparatus 1.

As the peripheral devices of the image processing apparatus 1, the camera 11, a personal computer (hereinafter written to as “PC”) 12, an image source device 13, a monitor/recorder 14, confirmation monitors 15 and 16, and an operation PC 17 are illustrated. These peripheral devices are examples for description.

The image processing apparatus 1 includes a central processing unit (CPU) 2, a graphics processing unit (GPU) 3, a flash read only memory (ROM) 4, a random access memory (RAM) 5, an input terminal 6 (6-1, 6-2, . . . , and 6-n), an output terminal 7 (7-1, 7-2, . . . , and 7-m), and a network communication unit 8.

The input terminal 6 includes n terminals from the input terminal 6-1 to the input terminal 6-n, and images of n systems can be input. Each input terminal 6 is, for example, a high-definition multimedia interface (HDMI, registered trademark) input terminal. Of course, the input terminal 6 is not limited to the HDMI input terminal, and may be a digital visual interface (DVI) terminal, an S terminal, an RGB terminal, a Y/C terminal, or the like.

For example, the camera 11 is connected to the input terminal 6-1 and image data as a camera image captured by the camera 11 is input. For example, the camera 11 captures the performer 62 as moving image imaging. In the present example, an example in which the camera image including the performer 62 is used as a moving object extraction target image in the image processing apparatus 1 will be described.

In the present disclosure, the “moving object extraction target image” is a term indicating image data in which a moving object is detected and an image thereof is extracted by the image processing apparatus 1. In the present example, the captured image (the image used as the second layer L2) supplied from the camera 11 is used as the moving object extraction target image. However, the present example is not limited to the example.

For example, the PC 12 is connected to the input terminal 6-2, and image data is input from the PC 12. For example, image data of the screen image, the background image, the logo image, or the like can be supplied from the PC 12.

Hereinafter, as an example for description, image data of the screen image to be displayed in the screen area 61 is assumed to be supplied from the PC 12.

Some sort of image source device 13 can be connected to another input terminal 6-n, and can input image data to be used for image synthesis to the input terminal 6-n.

What kind of device is connected to each input terminal 6 from the input terminal 6-1 to the input terminal 6-n is arbitrary, and the connection example in FIG. 3 is merely an example. A device serving as an image source may be connected to each input terminal 6 so that an image to be used for a synthesized image is input.

The output terminal 7 includes m terminals from output terminal 7-1 to output terminal 7-m, and an m-system image output is possible. Each output terminal 7 is, for example, an HDMI output terminal. Of course, the output terminal 7 is not limited to the HDMI terminal, and may be a DVI terminal, an S terminal, an RGB terminal, a Y/C terminal, or the like.

For example, the monitor/recorder 14 is connected to the output terminal 7-1. Here, the monitor/recorder 14 represents a monitor device, a recorder device, or a monitor and recorder device. The output terminal 7-1 is an example used for supplying a synthesis result to the monitor/recorder 14 as a master output (so-called main line image) to be used as image content. The image data of the synthesized image output from the output terminal 7-1 is displayed on the monitor/recorder 14 as the image content or recorded on a recording medium.

The confirmation monitors 15 and 16 are connected to the output terminals 7-2 and 7-m. The image processing apparatus 1 outputs, for example, image data to be monitored by an image production staff and the performer 62 from the output terminals 7-2 and 7-3 to the confirmation monitors 15 and 16. Thereby, the staff, the performer 62, and the like can check an image state.

What kind of device is connected to each output terminal 7 from the output terminal 7-1 to the output terminal 7-m is arbitrary, and the connection example in FIG. 3 is merely an example. A monitor device or a recorder device may be connected to each output terminal 7 as necessary. Furthermore, a communication device may be connected to the output terminal 7 and may be able to transmit the image data such as the synthesized image to an external device.

The CPU 2 performs processing for controlling an overall operation of the image processing apparatus 1.

The GPU 3 is used as a general-purpose computing on graphics processing unit (GPGPU) to realize high-speed image processing. The RAM 5 temporarily stores image processing results of image extraction and synthesis processing.

The flash ROM 4 stores a program that defines processing operations of the CPU 2 and the GPU 3. Furthermore, the flash ROM 4 is used as a storage area for various setting values such as a mask area and an absolute extraction area to be described below. Moreover, the flash ROM 4 stores the background image, the logo image, the screen image, and the like, and may function as a source of an image to be synthesized.

The network communication unit 8 is realized as an RJ45 Ethernet connector, for example, and performs network communication. Here, an example of performing communication with the operation PC 17 via a network is illustrated.

In this case, the image processing apparatus 1 is operated via the network. The image processing apparatus 1 serves as a web server, and an operator accesses an operation web page using the operation PC 17, and can perform an operation on the operation web page. For this purpose, the image processing apparatus 1 performs network connection with the operation PC 17 via the network communication unit 8 and performs communication by tcp/ip.

Note that the operation via the network is an example. The image processing apparatus 1 may be provided with an operation element, or operation information may be input to the image processing apparatus 1 using an operation device such as a keyboard, a mouse, a touch panel, a touchpad, or a remote controller, or an operation interface screen may be displayed on the confirmation monitor 15 or the like so that a staff can execute an operation on the screen.

For example, the image processing apparatus 1 illustrated in FIG. 3 is equipped with Linux (registered trademark) as an operation system.

Since a web page is used as a user interface for controlling the image processing apparatus 1, an https server is operating. The browser of the operation PC 17 communicates with a device by cgi, interprets a cgi command, and issues an instruction to the image processing program.

An image synthesis program has two states of a preparation state and an execution state, and performs various settings for synthesis in the preparation state, and synthesizes an input video and outputs a synthesis result image to the output terminal 7 in the execution state.

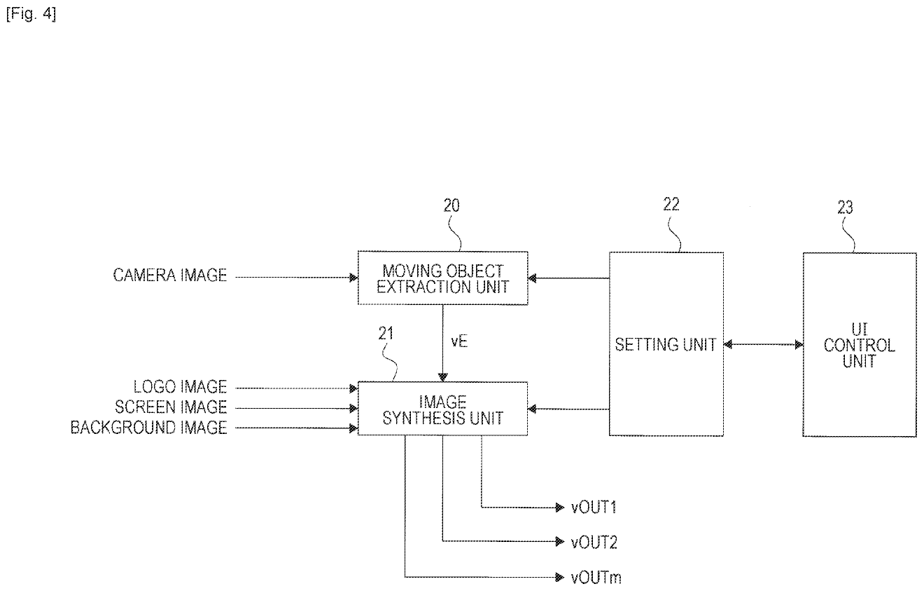

Processing functions realized by the hardware configurations as the CPU 2, the GPU 3, the flash ROM 4, and the RAM 5, and a software program in such an image processing apparatus 1 are illustrated in FIG. 4.

The processing functions to be realized include a moving object extraction unit 20, an image synthesis unit 21, a setting unit 22, and a user interface control unit 23. Note that, hereinafter, the term “user interface” is written as “UI”.

The moving object extraction unit 20 performs moving object extraction from the moving object extraction target image. As described above, for example, the captured image (camera image) supplied from the camera 11 is an example of the moving object extraction target image.

The moving object extraction unit 20 extracts an image of a moving object from an area other than the mask area set as an area where image extraction is not performed for the moving object extraction target image. Furthermore, the moving object extraction unit 20 extracts an image of the absolute extraction area set as an area from which an image to be used for synthesis is extracted, regardless of whether or not an object is a moving object. The moving object extraction unit 20 generates the extracted image vE on the basis of the extraction results and supplies the extracted image vE to the image synthesis unit 21 as an image to be used for the synthesis processing.

The moving object extraction unit 20 takes in the image data as the camera image to be input to the input terminal 6-1 and sets the image data as the moving object extraction target image. Then, the moving object extraction unit 20 extracts the images of the moving object and the absolute extraction area in the camera image, and outputs the images as the extracted image vE.

The image synthesis unit 21 performs processing of synthesizing the extracted image vE from the moving object extraction unit 20 with another image. As the another image, the logo image (top layer image vL1), the screen image (third layer image vL3), or the background image (bottom layer image vL4) is assumed.

For example, the image synthesis unit 21 synthesizes the image input by the input terminal 6-2 and the screen image, the background image, and the logo image as images read from the flash ROM 4 with the extracted image vE serving as the second layer image vL2.

Then, the image synthesis unit 21 outputs a generated synthesized image and the like from the output terminals 7-1, 7-2, and 7-m as, for example, output images vOUT1, vOUT2, and vOUTm. That is, the image synthesis unit 21 can output image data of a plurality of systems.

Each of the output images vOUT1, vOUT2, and vOUTm is a synthesized image, a preview image, or a left-right flipped image to be described below. In addition, an image input to the image synthesis unit 21, such as the extracted image vE, may be used as it is as the output image.

The UI control unit 23 prepares a setting screen 50 and an output monitor screen 80, which will be described below, using web pages, for example, and allows an operator (for example, a user of the operation PC 17) to perform an operation on the setting screen 50. Furthermore, the UI control unit 23 takes in operation information, and performs processing of reflecting operation content on the screen. In particular, the UI control unit 23 enables the operator to execute an operation for setting the mask area and the absolute extraction area.

The setting unit 22 has a function to store setting information set by the user by an operation on the setting screen 50 provided by the UI control unit 23, for example, in the flash ROM 4.

The setting information includes, for example, setting information for the mask area and absolute extraction area, selection information for the background image, setting for the screen area 61, selection information for the logo image, and the like.

In the above functions, for example, it is conceivable that the functions of the moving object extraction unit 20 and the image synthesis unit 21 are mainly realized by the GPU 3, and the functions of the UI control unit 23 and the setting unit 22 are mainly executed by the CPU 2. However, of course, all the functions may be mainly realized by the CPU 2 or may be mainly realized by the GPU 3. Any hardware configuration may be used as long as processing of each function can be executed.

<3. Setting Processing and UI>

An operation realized by the image processing apparatus 1 having the above configuration will be described. The processing to be described below is executed when the image processing apparatus 1 in FIG. 3 has the functions in FIG. 4.

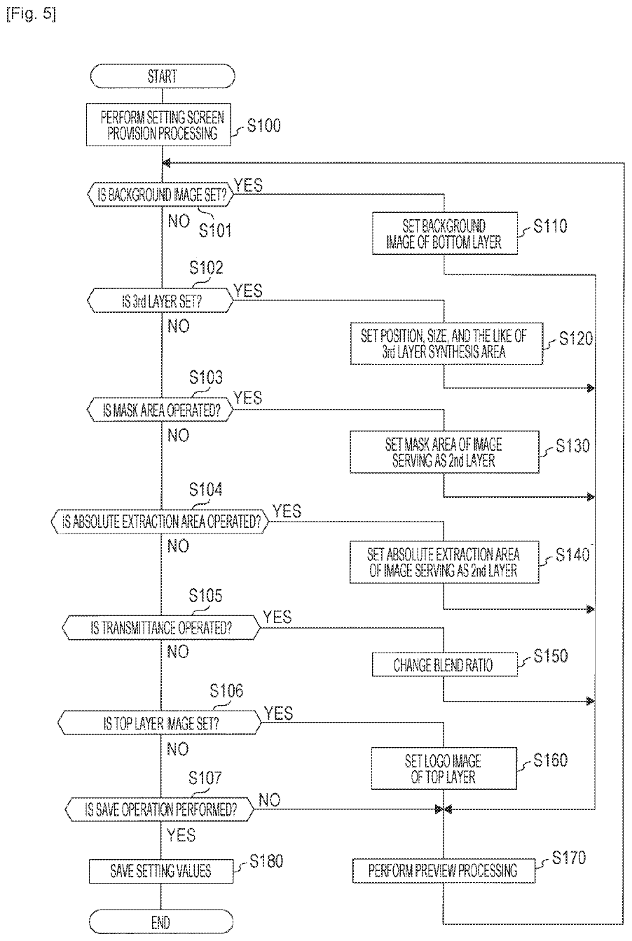

First, setting processing will be described with reference to FIGS. 5, 6, and 7. The setting processing is processing performed in the above-described preparation state.

The main processing content is as follows.

a) Selecting a background video

b) Setting of the screen area 61

c) Setting of the mask area

d) Setting of the absolute extraction area

e) Selection of the logo image and setting of an arrangement position and a size

By setting the above items, the image layer structure becomes the one illustrated in FIG. 2.

In particular, in the present embodiment, the above c) setting of the mask area and the above d) setting of the absolute extraction area can be performed, and the positions, shapes, and sizes of the areas can be adjusted while being compared with the camera image at the time of settings.

In the setting processing, the image processing apparatus 1 (the CPU 2 or the GPU 3) provides the setting screen 50 to the user in step S100 in FIG. 5 by the function of the UI control unit 23 and executes necessary processing in response to an operation while checking user operations in steps S101, S102, S103, S104, S105, S106, and S107.

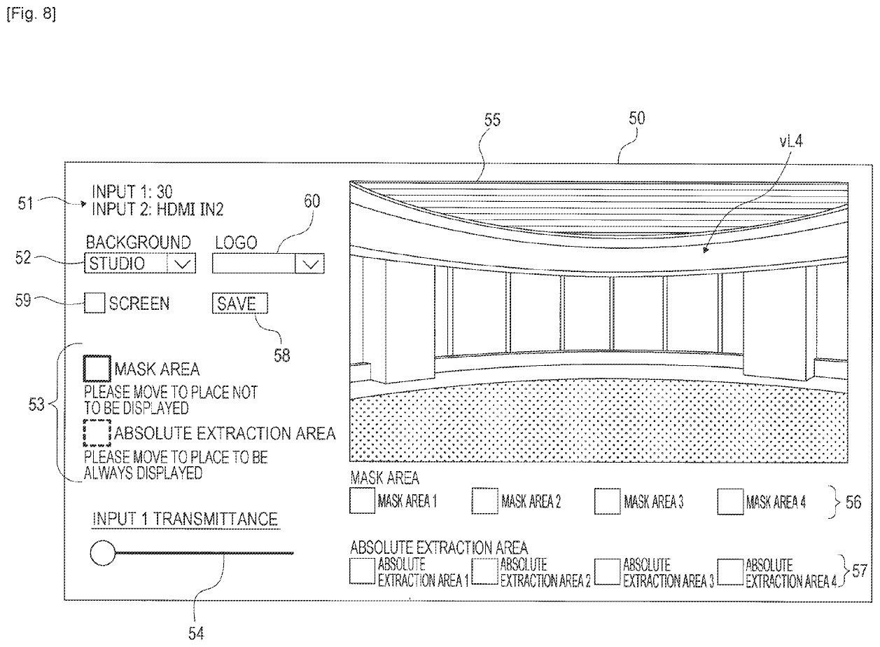

FIG. 8 illustrates an example of the setting screen 50 provided by the image processing apparatus 1 in step S100 for the user's operation.

On the setting screen 50, an input display section 51, a background selection section 52, an area setting description section 53, a transmittance adjustment bar 54, a preview area 55, a mask area check box 56, an absolute extraction area check box 57, a save button 58, a screen area check box 59, and a logo selection section 60 are prepared.

Note that such a setting screen is a mere example and the display content for the operation and the like are not limited to this example.

The preview area 55 appropriately displays an input image, the background image, the synthesized image, and the like in a setting process. The user can proceed with various settings while confirming the image in the preview area 55.

The input display section 51 displays devices or signal types to be connected to the input terminals 6-1, 6-2, and the like as input 1, input 2, and the like. For example, an image signal from the camera 11 being input to the input terminal 6-1 as the input 1 and an image signal from the PC 12 being input to the input terminal 6-2 as the input 2 are displayed using signal types, model names of connection devices, or the like.

The background selection section 52 has a pull-down menu format, for example, and the background image can be selected by selecting a background image name from the pull-down menu.

Similarly, the logo selection section 60 has a pull-down menu format, for example, and the logo image can be selected by selecting a logo image name from the pull-down menu.

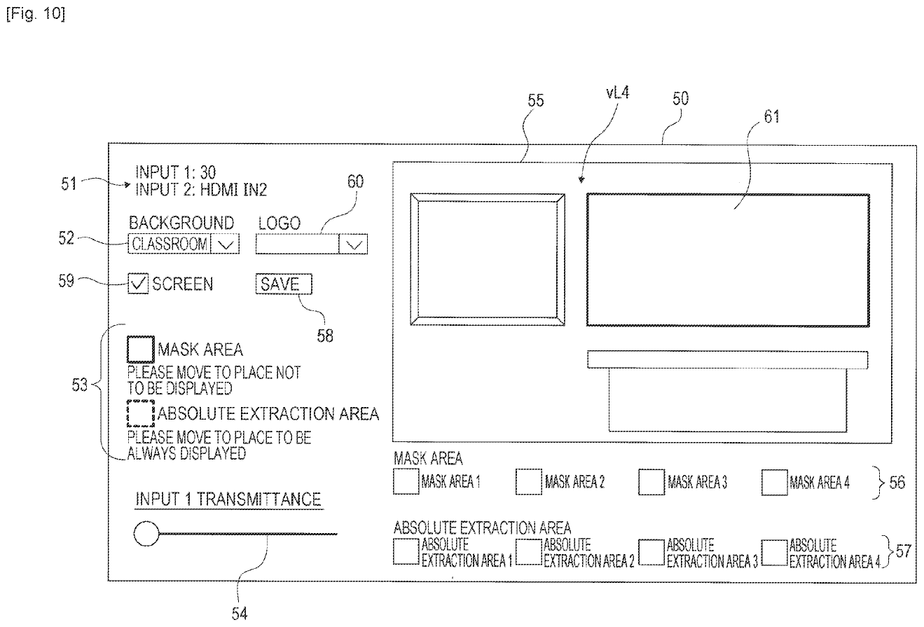

The screen area check box 59 is provided for on/off of the screen area 61. For example, by checking the screen area check box 59, the screen area 61 is displayed on the preview area 55 as illustrated in FIG. 10.

An image displayed on the screen area 61 is presented as the input 2 in the input display section 51, for example. For example, image data supplied from the PC 12 is HDMI image data, which will be the screen image.

The area setting description section 53 describes the mask area and the absolute extraction area.

The mask area is an area in which a moving object image used for synthesis is not extracted. That is, a subject image in the mask area is not included in the extracted image vE even if the subject image is a moving object.

For example, in a case of extracting a synthesis target from the camera image by a moving object extraction method, an unintended object may be extracted due to reflection on a window, movement of a curtain, or the like. To prevent such extraction, extraction of the unnecessary object can be avoided by specifying in advance the mask area where no moving object is extracted.

This mask area can be arbitrarily set by the user. In the present example, the user can arbitrarily set the position, size, and shape of the mask area on the screen of the preview area 55.

On the contrary, the absolute extraction area is an area in which an object image is included in the extracted image vE regardless of whether or not the object image is a moving object, that is, even if the object image is a stationary object. For example, there is an object image that is usually not extracted by the moving object extraction processing because the object image is not a moving object but the object image is desired to be included in the synthesized image. For example, the absolute extraction area is used in a case where there is an object near the performer 62 and the object is desired to be necessarily captured together with the performer 62. This absolute extraction area can also be arbitrarily set by the user. In the present example, the user can arbitrarily set the position, size, and shape of the absolute extraction area on the screen of the preview area 55, similarly to the mask area.

Four check boxes (“mask area 1” to “mask area 4”) are prepared as the mask area check box 56, and four check boxes (“absolute extraction area 1” to “absolute extraction area 4”) are prepared as the absolute extraction area check box 57.

When the user checks a check box, the corresponding mask area or absolute extraction area appears in the preview area 55. In this example, a maximum of four mask areas and a maximum of four absolute extraction areas can be set.

The transmittance adjustment bar 54 is an operation element for adjusting the transmittance of the camera image displayed in the preview area 55. The transmittance in this case can be paraphrased as, for example, a blend ratio of alpha blending processing with a background image or the like.

For example, by providing such a setting screen 50 as a web page, the user can perform an operation using the operation PC 17.

In the setting processing, the user first sets the background image.

When detecting an operation to set the background image by the user, the image processing apparatus 1 advances the processing from step S101 to step S110 in FIG. 5, and sets the background image to be used as the bottom layer image vL4. Then, in step S170, the image processing apparatus 1 executes control for displaying a preview image in accordance with a background setting in the preview area 55.

Specifically, when the user selects a specific background from the pull-down menu by operating the background selection section 52, the image processing apparatus 1 sets the background image of the selected background as the bottom layer image vL4. For example, background images such as “studio”, “classroom”, “laboratory”, “library”, and “park” are prepared. These background images as selection candidates are, for example, images stored in the flash ROM 4, or images that can be acquired from the PC 12 or another image source device 13. Then, the background image in accordance with the selection of the user is displayed in the preview area 55.

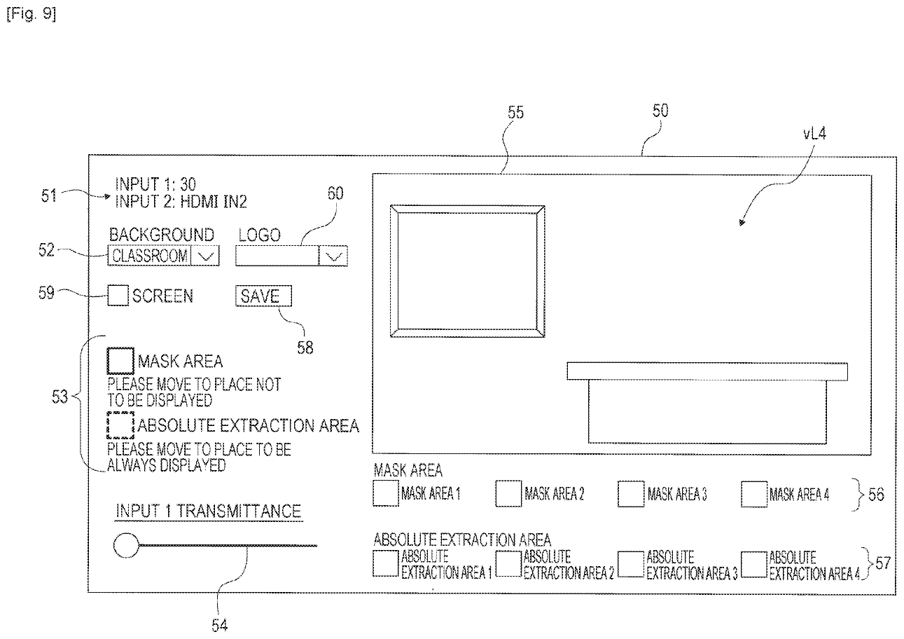

FIG. 8 illustrates a state in which the user has selected “studio”, and FIG. 9 illustrates a state in which the user has selected “classroom”. As described above, the image processing apparatus 1 performs the background image setting in step S110 in accordance with a user's selection operation such that the background image is displayed in the preview area 55 in step S170. The user can select a desired background image as the bottom layer image vL4 while checking the background image.

For example, following the background image setting, the user can set the third layer by performing an operation to check the screen area check box 59.

In response to the operation regarding the screen area 61, the image processing apparatus 1 proceeds from step S102 to step S120 in FIG. 5 and performs processing of setting the position and size of an area where the third layer synthesis is performed, that is, the screen area 61. Then, the image processing apparatus 1 generates the preview image including the screen area 61 in step S170 on the basis of the settings and displays the preview image in the preview area 55.

For example, in a case of detecting the check operation of the screen area check box 59, the image processing apparatus 1 sets the screen area 61 with, for example, a predetermined position as an initial position and a predetermined size in step S120, and performs processing of displaying the screen area 61 in the preview area 55 in step S170.

FIG. 10 illustrates a state in which the screen area 61 is displayed to overlap with the previously selected background image (classroom), for example.

Note that the screen area 61 may be set with preset position and size and displayed in the above-described background setting.

Furthermore, regarding the screen area 61, it is conceivable to make operations such as movement, enlargement, reduction, and deformation possible by operations such as dragging and clicking. Whenever these operations are detected, the image processing apparatus 1 proceeds from step S102 to step S120, and changes the settings such as the position and size of the screen area 61 in response to the operations, and displays the screen area 61 for which the movement, enlargement, reduction, deformation, and the like have been performed in step S170. Note that it is desirable to perform the enlargement and reduction while maintaining an aspect ratio.

As a result, the user can set the screen area 61 with arbitrary position, size, and the like.

When detecting an operation regarding the mask area, the image processing apparatus 1 proceeds from step S103 to step S130 and performs processing of setting the mask area to be applied to an image to be synthesized with the second layer image vL2, that is, the camera image.

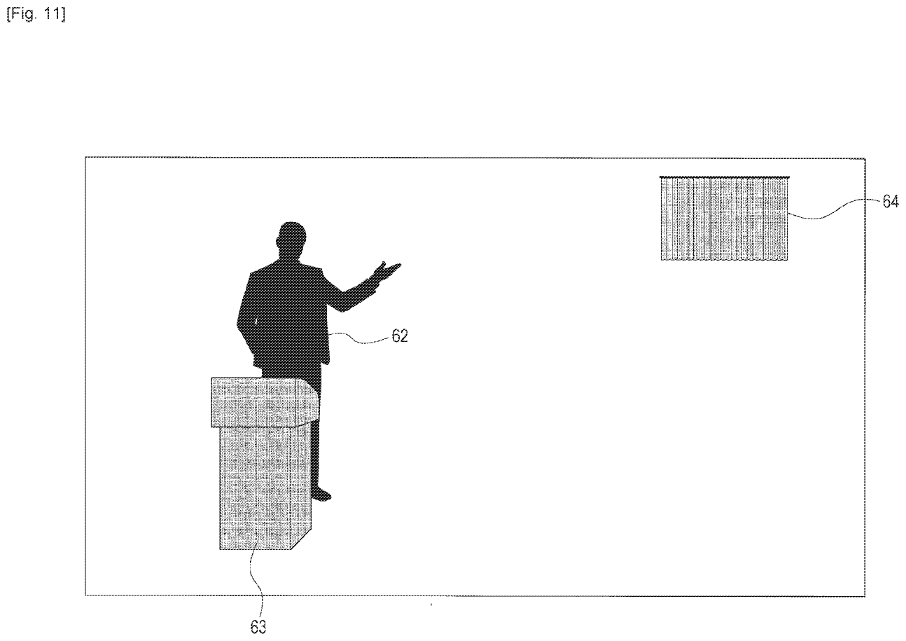

For example, the camera image as illustrated in FIG. 11 is assumed. This camera image is mainly for capturing the performer 62, and is obtained by asking the performer 62 to do a performance at a certain place and imaging the performer 62 with the camera 11. At this time, a window with a closed curtain 64 as illustrated in FIG. 11 is assumed to exist at the imaging place. This curtain 64 is not desired to be included in the synthesized image.

Since the curtain 64 is not moving, the curtain 64 is normally not extracted in the moving object extraction processing. However, the curtain 64 may move due to wind blowing or the like, and during that period, the curtain 64 may be extracted as a moving object and included in the extracted image vE. That is, the curtain 64 may appear in the synthesized image only during a certain frame period. The mask area is set in such a range of the curtain 64. Then, even if the curtain 64 moves, since the curtain 64 is within the mask area, the curtain 64 is excluded from the target for the moving object extraction processing, and is not extracted and does not appear in the synthesized image.

The operations regarding the mask area include an operation to check/uncheck the mask area check box 56 and an operation for the position, size, shape, and the like of the mask area. In response to these operations, the image processing apparatus 1 performs the processing of setting the mask area according to the operation in step S130 in FIG. 5, and displays a setting state of the mask area in step S170.

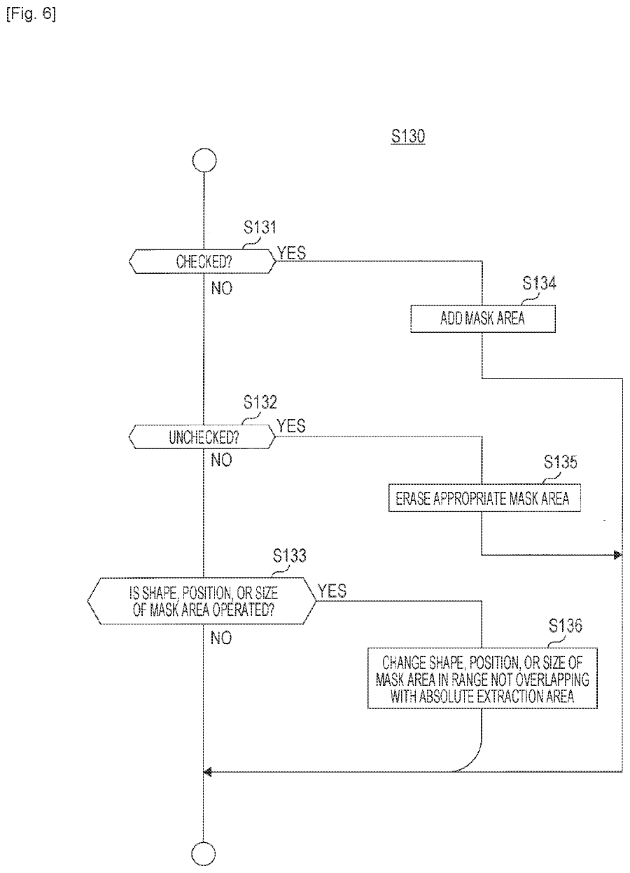

The processing in step S130 is illustrated in detail in FIG. 6. First, to set the mask area, the user performs an operation to cause a mask frame 70 indicating the mask area to appear in the preview area 55 by checking the mask area check box 56. In a case where the check operation on the mask area check box 56 is performed and the processing proceeds to step S130 in FIG. 5, the image processing apparatus 1 proceeds from step S131 to step S134 in FIG. 6, and adds a valid mask area in an initial setting state, for example. Then, the image processing apparatus 1 displays the mask area by the mask frame 70 in step S170 in FIG. 5.

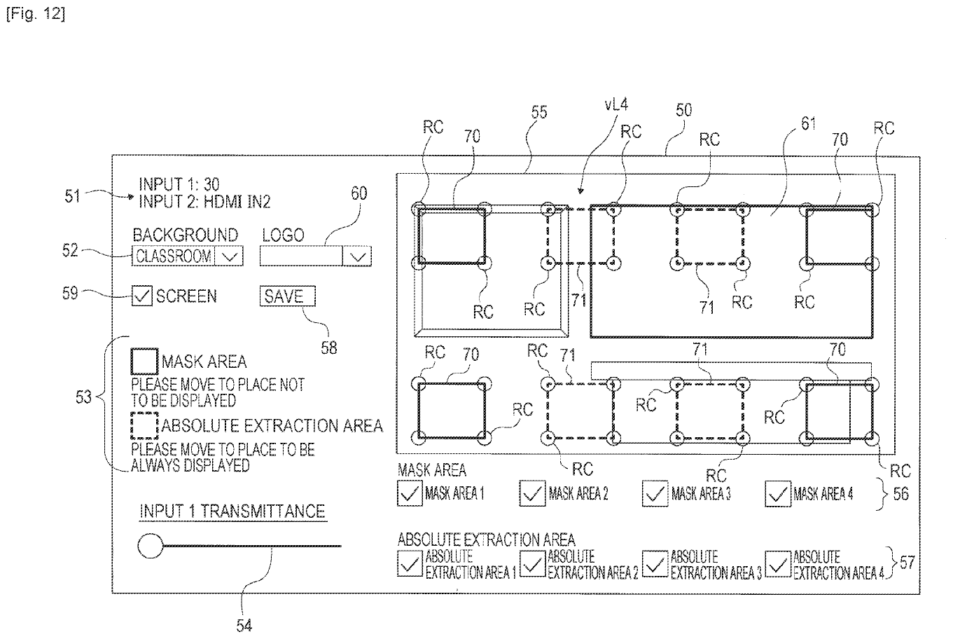

FIG. 12 illustrates four mask frames 70 as rectangular solid lines. Each mask frame 70 indicates the mask area validated in each initial setting state (the position, size, and shape).

On the other hand, when an operation to uncheck the mask area check box 56 is performed, the image processing apparatus 1 similarly proceeds from step S103 to step S130 in FIG. 5. In this case, the processing proceeds from step S132 to step S135 in FIG. 6, and the image processing apparatus 1 invalidates the setting of the mask area corresponding to the unchecked check box and erases the corresponding mask frame 70 in step S170 in FIG. 5.

The user can display an arbitrary number from 0 to 4 of mask frames 70 by checking or unchecking the mask area check box 56.

For example, operation circles RC are displayed at four corners of the mask frame 70, and the user can change the size and shape of the mask frame 70 by dragging the portion of the operation circle RC.

Furthermore, the size may be enlarged/reduced by an operation such as clicking, double-clicking, or pinching in/out in the mask frame 70. Furthermore, the position may be moved by specifying and dragging an inside of the mask frame 70. Furthermore, the shape may be changed from a square to a triangle, a circle, an ellipse, a polygon, an indefinite shape, or the like by an operation to trace a touch panel screen.

Even in a case of detecting the operations to change the position, size, and shape of the mask area, the image processing apparatus 1 proceeds from step S103 to step S130 in FIG. 5. In this case, the image processing apparatus 1 proceeds from step S133 to step S136 in FIG. 6, and changes the setting of the position, size, or shape of the mask area. Then, the image processing apparatus 1 proceeds to step S170 in FIG. 5 and displays the mask area for which the setting has been changed by the position, size, or shape of the mask frame 70.

Note that, in step S136, the image processing apparatus 1 does not indefinitely respond to the operation for the setting change in the position, size, and shape of the mask area, and limits the operation so as to cause a change within a range not overlapping with the absolute extraction area. This will be described after the description of the absolute extraction area.

When the image processing apparatus 1 performs steps S103 and S130 in FIG. 5 above (the processing in FIG. 6), the user can set an arbitrary number of mask areas at arbitrary positions, sizes, and shapes.

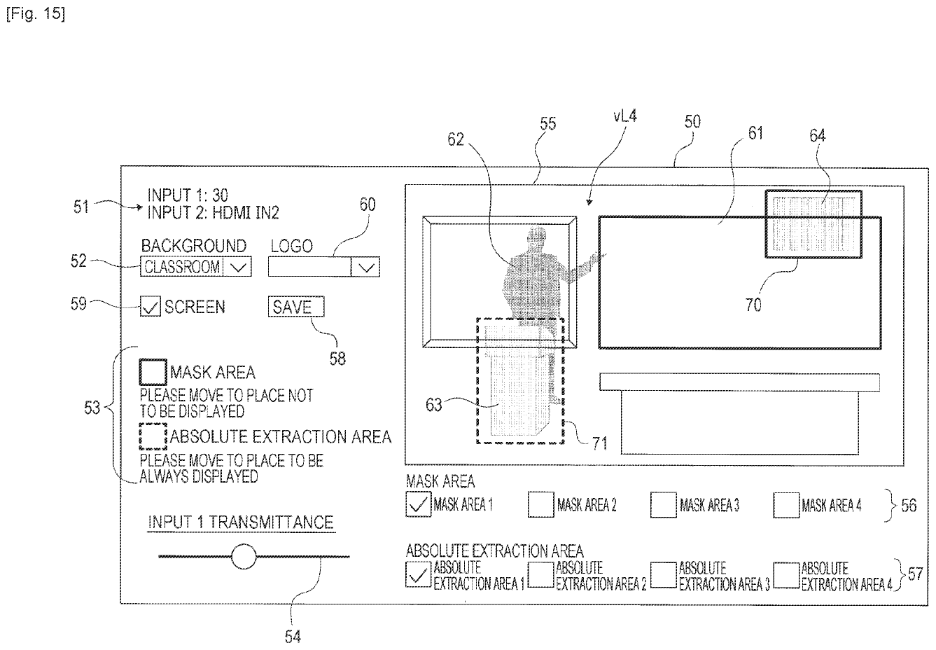

FIG. 15 illustrates an example in which one mask area is set around the curtain 64, as illustrated by the mask frame 70, in a state where the camera image is displayed in the preview area 55.

In a case of detecting an operation regarding the absolute extraction area, the image processing apparatus 1 proceeds from step S104 to step S140 in FIG. 5 and performs processing of setting the absolute extraction area to be applied to an image to be synthesized as the second layer image vL2, that is, the camera image.

In the case of the camera image illustrated in FIG. 11, for example, an image producer is assumed to desire extraction of a podium 63 together with the performer 62, that is, to desire the podium 63 to appear in the synthesized image. However, since the podium 63 is not a moving object, the podium 63 is not extracted by the moving object extraction processing. In such a case, the absolute extraction area is set. By setting the absolute extraction area, the image processing apparatus 1 extracts an image in the absolute extraction area even if the image is not a moving object and includes the image in the extracted image vE in the moving object extraction processing. That is, the image appears in the synthesized image.

The operations regarding the absolute extraction area include an operation to check/uncheck the absolute extraction area check box 57 and an operation for the position, size, shape, and the like of the absolute extraction area. In response to these operations, the image processing apparatus 1 performs the processing of setting the absolute extraction area according to the operation in step S140, and displays a setting state of the absolute extraction area in step S170.

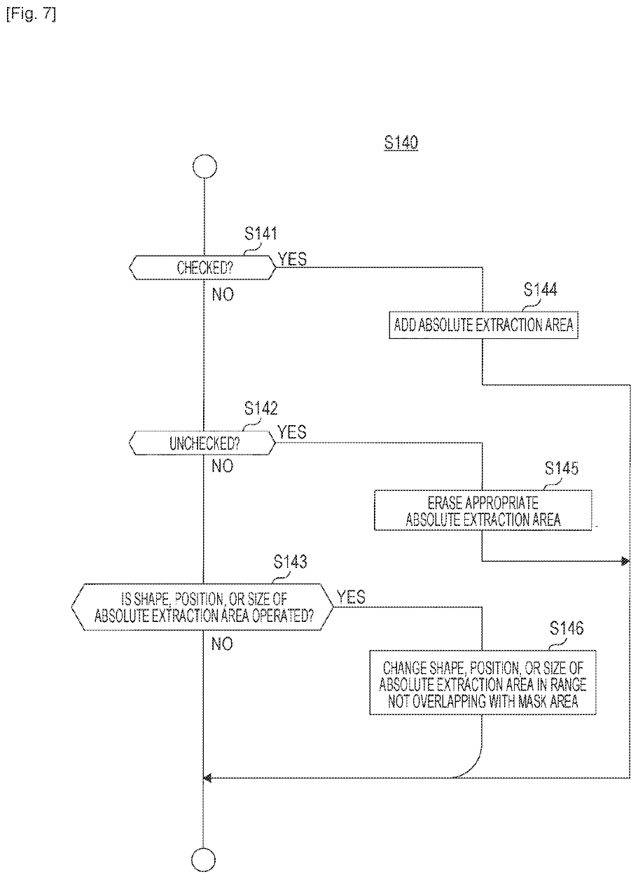

The processing in step S140 is illustrated in detail in FIG. 7. First, to set the absolute extraction area, the user performs an operation to cause an absolute extraction frame 71 indicating the absolute extraction area to appear in the preview area 55 by checking the absolute extraction area check box 57.

In a case where the check operation on the absolute extraction area check box 57 is performed and the processing proceeds to step S140 in FIG. 5, the image processing apparatus 1 proceeds from step S141 to step S144 in FIG. 7, and adds a valid absolute extraction area in an initial setting state, for example. Then, the image processing apparatus 1 displays the absolute extraction area by the absolute extraction frame 71 in step S170 in FIG. 5.

FIG. 12 illustrates four absolute extraction frames 71 as rectangular broken lines. Each absolute extraction frame 71 indicates an absolute extraction area validated in each initial setting state (the position, size, and shape).

Note that FIG. 12 illustrates the mask frame 70 with the solid lines and the absolute extraction frame 71 with the broken lines, which indicates that display modes of the mask frame 70 and the absolute extraction frame 71 are different.

In this way, the display modes may be differentiated by the difference in type of the fame lines or the difference in color of the frame lines. Furthermore, instead of being displayed as frames, the mask area may be displayed as a blue translucent area and the absolute extraction area may be displayed as a purple translucent area, as translucent areas, for example. In any case, the display modes are differentiated to enable the user to distinguish the mask area and the absolute extraction area on the display.

When an operation to uncheck the absolute extraction area check box 57 is performed, the image processing apparatus 1 similarly proceeds from step S104 to step S140 in FIG. 5. In this case, the processing proceeds from step S142 to step S145 in FIG. 7, and the image processing apparatus 1 invalidates the setting of the absolute extraction area corresponding to the unchecked check box and erases the corresponding absolute extraction frame 71 in step S170 in FIG. 5.

The user can display an arbitrary number from 0 to 4 of absolute extraction frames 71 by checking or unchecking the absolute extraction area check box 57.

For example, operation circles RC are displayed at four corners of the absolute extraction frame 71, and the user can change the size and shape of the absolute extraction frame 71 by dragging the portion of the operation circle RC.

Furthermore, the size may be enlarged/reduced by an operation such as clicking, double-clicking, or pinching in/out in the absolute extraction frame 71. Furthermore, the position may be moved by specifying and dragging an inside of the absolute extraction frame 71. Furthermore, the shape may be changed from a square to a triangle, a circle, an ellipse, a polygon, an indefinite shape, or the like by an operation to trace a touch panel screen.

Even in a case of detecting the operations to change the position, size, and shape of the absolute extraction area, the image processing apparatus 1 proceeds from step S104 to step S140 in FIG. 5. In this case, the image processing apparatus 1 proceeds from step S143 to step S146 in FIG. 7, and changes the setting of the position, size, or shape of the absolute extraction area. Then, the image processing apparatus 1 proceeds to step S170 in FIG. 5 and displays the absolute extraction area for which the setting has been changed by the position, size, or shape of the absolute extraction frame 71.

When the image processing apparatus 1 performs steps S104 and S140 in FIG. 5 above (the processing in FIG. 7), the user can set an arbitrary number of absolute extraction areas at arbitrary positions, sizes, and shapes.

FIG. 15 illustrates an example in which one absolute extraction area is set around the podium 63, as illustrated by the absolute extraction frame 71, in the state where the camera image is displayed in the preview area 55.

Note that, in step S146 in FIG. 7, the image processing apparatus 1 does not indefinitely respond to the operation for the setting change in the position, size, and shape of the absolute extraction area, and limits the operation so as to cause a change within a range not overlapping with the mask area.

The limitation of the operation has been described in step S136 in FIG. 6. The limitations of the operations will be collectively described.

If the user can arbitrarily set the positions, sizes, and shapes of the mask area and the absolute extraction area, there is a possibility of occurrence of an overlap of the mask area and the absolute extraction area. If the mask area and the absolute extraction area overlap, a priority needs to be given to either the mask area or the absolute extraction area in the moving object extraction processing. However, which is prioritized is not able to be completely determined. Therefore, even if there is a setting change operation, the operation is invalidated in a case where the mask area and the absolute extraction area overlap.

For example, in a case where a part of a certain mask area overlaps with the absolute extraction area in a case where the user performs the operation to move the mask area, the mask area can be moved only just before the overlap. For example, from the viewpoint of the user, the mask frame 70 is displayed such that the mask frame 70 is not able to be moved in an overlapping direction after hitting the absolute extraction frame 71.

Similarly, for example, in a case where a part of a certain absolute extraction area overlaps with the mask area in a case where the user performs the operation to move the absolute extraction area, the absolute extraction area can be moved only just before the overlap. For example, from the viewpoint of the user, the absolute extraction frame 71 is displayed such that the absolute extraction frame 71 is not able to be moved in the overlapping direction after hitting the mask frame 70.

The shapes and sizes are similarly changed. The changes in the shape and size of the mask area (mask frame 70) are valid within a range where the mask area does not overlap with the absolute extraction area (absolute extraction frame 71). Furthermore, the changes in the shape and size of the absolute extraction area (absolute extraction frame 71) are valid within a range where the absolute extraction area does not overlap with the mask area (mask frame 70).

In steps S136 and S146, the user's setting change operation is accepted within the range where the mask area and the absolute extraction area do not overlap, and the settings are changed. Note that such a limitation is not necessary in a case where no problem occurs even if an overlap occurs by a design concept of prioritizing either the mask area or the absolute extraction area.

The setting processing for the mask area and the absolute extraction area is performed as described above, but it is desirable for the user to check not only the background image and the screen area 61 but also the camera image at the time of the setting operations. The user can check the content of the camera image in the preview area 55 by operating the transmittance adjustment bar 54.

When detecting the operation of the transmittance adjustment bar 54, the image processing apparatus 1 proceeds from step S105 to step S150 in FIG. 5, changes the blend ratio of the camera image in accordance with the operation, and reflects the change in generation of the preview image in step S170.

This setting processing is performed in the preparation stage and it is assumed that actual imaging has not been performed, depending on the camera 11. Therefore, rehearsal imaging is performed in an environment where actual imaging is performed, and the camera image is input to the image processing apparatus 1, depending on the camera 11. The performer 62 or a staff instead of the performer may be captured.

The preview image displayed in the preview area 55 is display content indicating the background image and the screen area 61 that have been selected and set so far, but the preview image can be an image synthesized with the camera image being rehearsed at the point of time (at the time of preparation processing). Then, the synthesis ratio of the camera image to the background image or the like is variably set by the operation of the transmittance adjustment bar 54.

FIG. 12 illustrates an example in which the camera image is in a maximum transmittance state. That is, the camera image is not able to be visually recognized in the preview area 55.

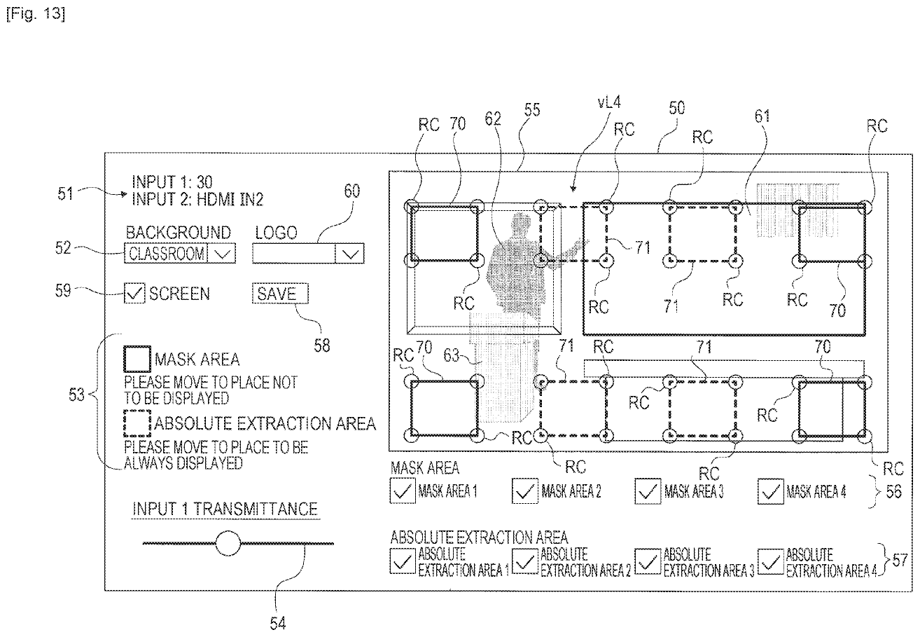

FIG. 13 illustrates a case of lowering the transmittance (raising the blend ratio) of the camera image in accordance with the operation of the transmittance adjustment bar 54. The camera image including the performer 62, the podium 63, the curtain 64, and the like can be visually recognized together with the background image and the like.

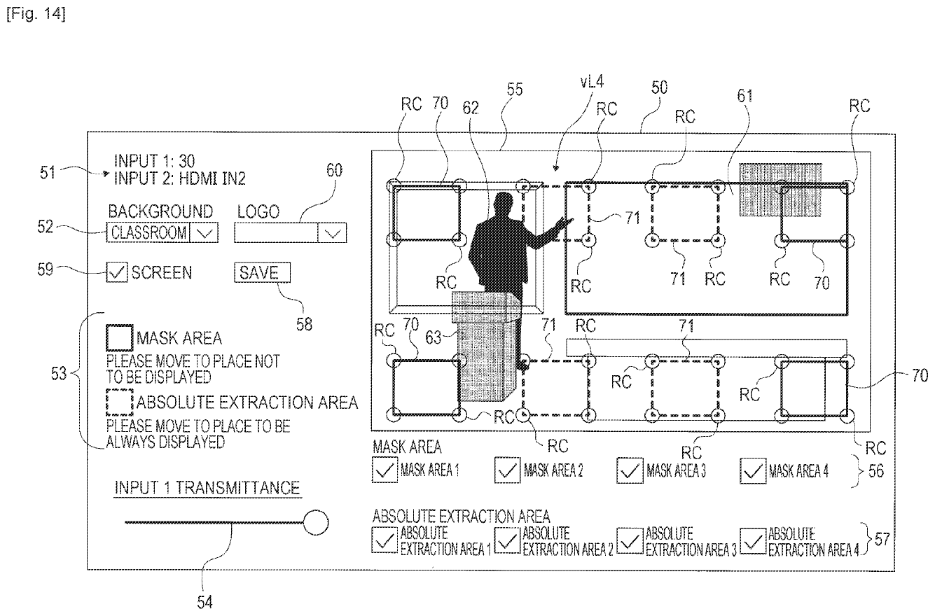

FIG. 14 illustrates a case of minimizing the transmittance (maximizing the blend ratio) of the camera image in accordance with the operation of the transmittance adjustment bar 54. The camera image can be clearly visually recognized together with the background image and the like.

The user can set the mask area and the absolute extraction area while performing the operation to vary the blend ratio for the image (the camera image in this example) to be used for the second layer L2. Thereby, the user can set the mask area and the absolute extraction area while confirming the position of an object included as a subject in the camera image.

Furthermore, the blend adjustment of the camera image by the operation of the transmittance adjustment bar 54 is performed when the background image is selected or when the third layer is set (the screen area 61 is set), so that the background image can be selected according to the performer 62 and the podium 63 extracted from the camera image, and the screen area 61 can be appropriately arranged.

Thus, for example, each setting can be adjusted while comparing the positional relationship among the images of the respective layers and the angle of view of the camera image.

In the setting processing, the top layer image vL1 is set, for example, the logo image is selected.

When detecting an operation to set the top layer image by the user, the image processing apparatus 1 advances the processing from step S106 to step S160 in FIG. 5, and sets the logo image to be used as the top layer image vL1. Then, in step S170, the image processing apparatus 1 executes control for superimposing and on the preview image displaying the superimposed logo image in the preview area 55.

Specifically, when the user selects a specific logo design from the pull-down menu by operating the logo selection section 60, the image processing apparatus 1 sets the logo image of the selected logo design as the top layer image vL1. These logo images as selection candidates in the pull-down menu are, for example, images stored in the flash ROM 4, or images that can be acquired from the PC 12 or another image source device 13. Furthermore, when the user performs a predetermined operation such as clicking or dragging on the logo image, the image processing apparatus 1 performs setting change such as size adjustment by enlarging or reducing the logo image while maintaining the aspect ratio, or arrangement of the logo image at an arbitrary position in step S160.

The logo image is also synthesized with the preview image and displayed in the preview area 55 in step S170.

After setting all or part of the background image, the screen area 61, the mask area, the absolute extraction area, and the logo image, as described above, the user performs an operation to save the settings.

When detecting that the user has operated the save button 58, the image processing apparatus 1 proceeds from step S107 to step S180 in FIG. 5, and saves setting values.

For example, the image processing apparatus 1 stores setting information of the background image, the range of the screen area 61, the range of the mask area, the range of the absolute extraction area, the logo image, and the like in the flash ROM 4.

The setting processing is completed.

Note that the actual setting procedure, processing, operation content, and the like can be considered in various ways.

A full screen may be used as the screen area 61, and the screen image may be used as the background.

For the mask area, it is conceivable to perform, as a default setting, object recognition from image recognition, and to set an area of the object as the mask area as an initial state, when the detected object is to be masked. For example, in a case where there are a window, a curtain, a clock, and the like in the camera image, they are recognized and automatically set as the mask areas in the initial state.

Similarly, regarding the setting of the absolute extraction area, object recognition can be used. For example, in a case where a predetermined object is recognized in the camera image, the area of the object may be initially set as the absolute extraction area.

Furthermore, it is conceivable to specify a target object in accordance with a theme that is meant by the background image. For example, in a case where the background image is a news studio and the podium 63 is found in the camera image, the area of the podium 63 is automatically set as the absolute extraction area. Furthermore, in a case where the background image is a laboratory and a whiteboard is found, the area of the whiteboard is automatically set as the absolute extraction area.

<4. Synthesis Processing and UI>

After the above setting processing is performed as the preparation state, an image output by actual image synthesis processing is performed as the execution state. The synthesis processing and a UI in this case will be described.

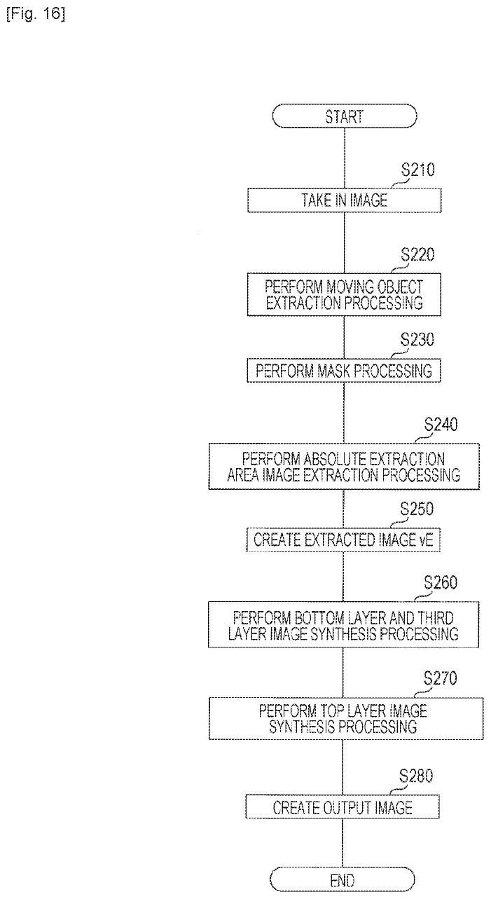

FIG. 16 illustrates a processing example performed by the image processing apparatus 1 (the CPU 2 or the GPU 3) as the execution state. FIG. 16 illustrates a processing example performed at every frame timing for the camera image supplied from the camera 11, for example.

The processing from step S210 to step S250 is executed by the image processing apparatus 1 using the function of the moving object extraction unit 20 in FIG. 4.

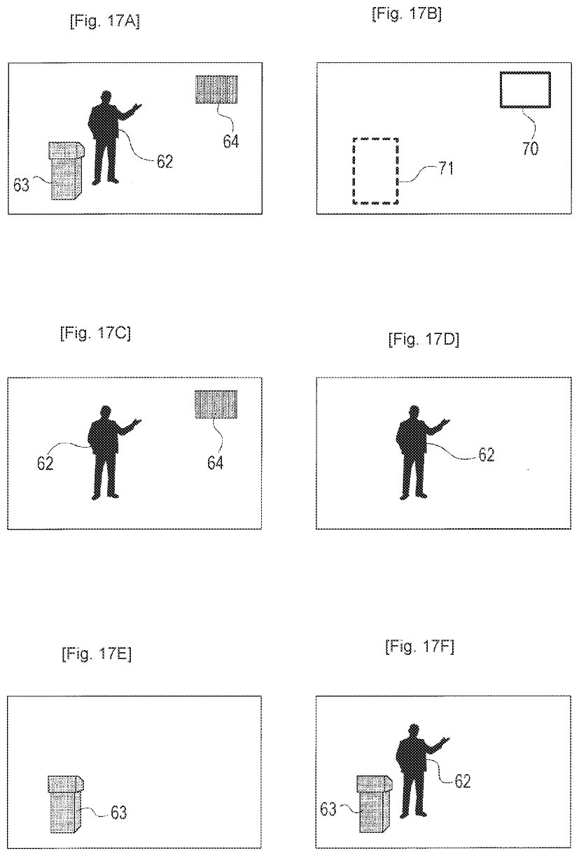

In step S210, the image processing apparatus 1 acquires one frame of image data as the camera image. For example, as illustrated in FIG. 17A, the image processing apparatus 1 takes in, as processing targets, one frame of the camera image including the performer 62, the podium 63, the curtain 64, and the like as subjects.

Note that it is assumed that the mask area and the absolute extraction area are set as illustrated by the mask frame 70 and the absolute extraction frame 71 in FIG. 17B in the setting processing at the preparation stage.

In step S220, the image processing apparatus 1 performs the moving object extraction processing. For example, the image processing apparatus 1 compares the frame acquired at this time with a previous frame, detects a subject with a difference, and extracts an image of the subject.

The moving object extraction result is illustrated in FIG. 17C. Here, the performer 62 is extracted. Furthermore, due to the movement of the curtain 64 which is an actual subject, even an image of the curtain 64 not intended by the producer is also extracted. Note that, at this stage, since the mask area processing is not reflected, this extraction can be said to be a tentative moving object extraction.

In step S230, the image processing apparatus 1 performs the mask processing. That is, the mask processing is processing of not extracting a moving object as an image to be used for synthesis processing, for an image existing in the mask area set in the preparation processing.

Even if an image as a moving object is extracted as illustrated in FIG. 17C, the moving object image is not able to be an image (extracted image vE) finally extracted as an image to be used for synthesis processing as it is. For example, in a case where the area of the curtain 64 is set as the mask area, the curtain 64 tentatively extracted as a moving object is an image of the area that is set not to be extracted. Therefore, the curtain 64 is not extracted as a moving object. As a result, the moving object extraction result is only the performer 62 as illustrated in FIG. 17D.

Note that, in the above example, processing of invalidating a moving object so as not to be extracted as an image to be used for synthesis in the mask area range after extracting moving objects in the entire screen has been described. However, steps S220 and S230 may be performed as processing of not detecting moving objects in the mask area from the beginning.

In any case, the mask area may only be required to become an area in which image extraction is not performed as a result. In other words, the extracted image vE may only be required not to include an image of the mask area.

In step S240, the image processing apparatus 1 performs the image extraction processing for the absolute extraction area in the camera image. That is, the image extraction processing is processing of extracting an image from the absolute extraction area set in the preparation processing. In this case, the extraction means that an image that is not a moving object is extracted. As a result, for example, the podium 63 is extracted as illustrated in FIG. 17E.

In step S250, the image processing apparatus 1 creates the extracted image vE. That is, the moving object extraction unit in FIG. 4 creates an image to be transferred to the image synthesis unit 21.

The extracted image vE is an image obtained by extracting a moving object from an area other than the mask area set as an area where image extraction is not performed, for the camera image as the moving object extraction target image. Furthermore, the extracted image vE is an image obtained by extracting an image of the absolute extraction area set as an area in which image extraction is necessarily performed, regardless of whether or not an object is a moving object.

The extracted image vE is a combined image of the image in FIG. 17D and the image in FIG. 17E, and results in an image as illustrated in FIG. 17F.

When the extracted image vE is generated as described above, the image processing apparatus 1 executes processing from step S260 to S280 in FIG. 16 by the function of the image synthesis unit 21 in FIG. 4.

In step S260, the image processing apparatus 1 synthesizes the extracted image vE, the bottom layer image vL4, and the third layer image vL3. That is, the image processing apparatus 1 performs the synthesis processing of synthesizing the extracted image vE with the background image selected at the preparation stage, and fitting, for example, the screen image into the screen area 61. The screen image is image data supplied from the PC 12, for example.

In step S270, the image processing apparatus 1 synthesizes the top layer image vL1. That is, the image processing apparatus 1 synthesizes the logo image selected at the preparation stage and for which the position and size have been set.

At this stage, a synthesized image in which the images of the four layers have been synthesized is generated.

In step S280, the image processing apparatus 1 creates an output image. That is, the image processing apparatus 1 generates image data (output images vOUT1, vOUT2, . . . , and vOUTm) to be output from the output terminals 7-1, 7-2, . . . , and 7-m.

For example, the image data of the synthesized image is output from the output terminal 7-1 as the output image vOUT1 to the monitor/recorder 14. The synthesized image is output as a so-called main line image.

Image data similar to the main line image may be output from the output terminal 7-2 and the subsequent output terminals, but for example, the image processing apparatus 1 may generate image data for generating an output monitor screen for enabling the staff to monitor images and to perform a predetermined operation.

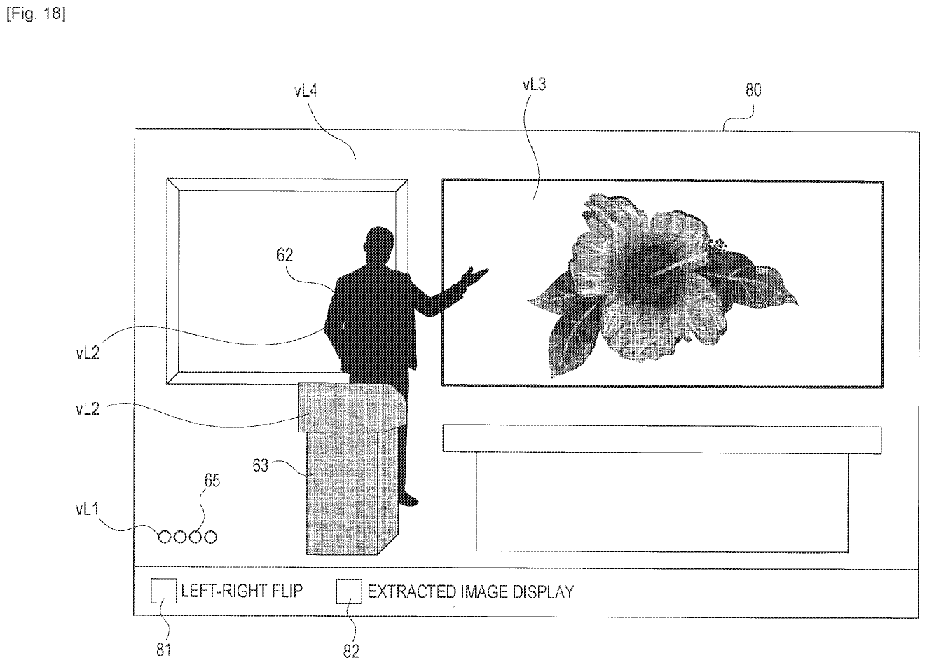

For example, the image processing apparatus 1 generates image data for displaying the output monitor screen 80 as illustrated in FIG. 18 and outputs the image data from the output terminal 7-2 as the output image vOUT2.

The output monitor screen 80 includes the synthesized image of the top layer image vL1, the second layer image vL2, the third layer image vL3, and the bottom layer image vL4, and is also provided with a left-right flip check box 81 and an extracted image check box 82.

For example, the confirmation monitors 15 and 16 are secured to have interfaces not only simply receiving input image data from the image processing apparatus 1 but also allowing the CPU 2 to detect an operation on the screen of the confirmation monitor 15.

For example, it is conceivable that the output terminals 7-2 and 7-3 may be bidirectional communication terminals, or the confirmation monitors 15 and 16 may be communicable via the network communication unit 8.

For example, when the left-right flip check box 81 and the extracted image check box are not checked in the confirmation monitors 15 and 16, the image processing apparatus 1 generates the image data for displaying the image as illustrated in FIG. 18 as the output images vOUT2, . . . , and vOUTm, and outputs the output images vOUT2, . . . , and vOUTm from the output terminals 7-2, . . . , and 7-m.

Since the processing in FIG. 16 is performed at timing of each frame, the staff who visually recognizes the confirmation monitor 15 or the confirmation monitor 16 can see the image as illustrated in FIG. 18 as the synthesized image of a state where the performer 62 is performing.

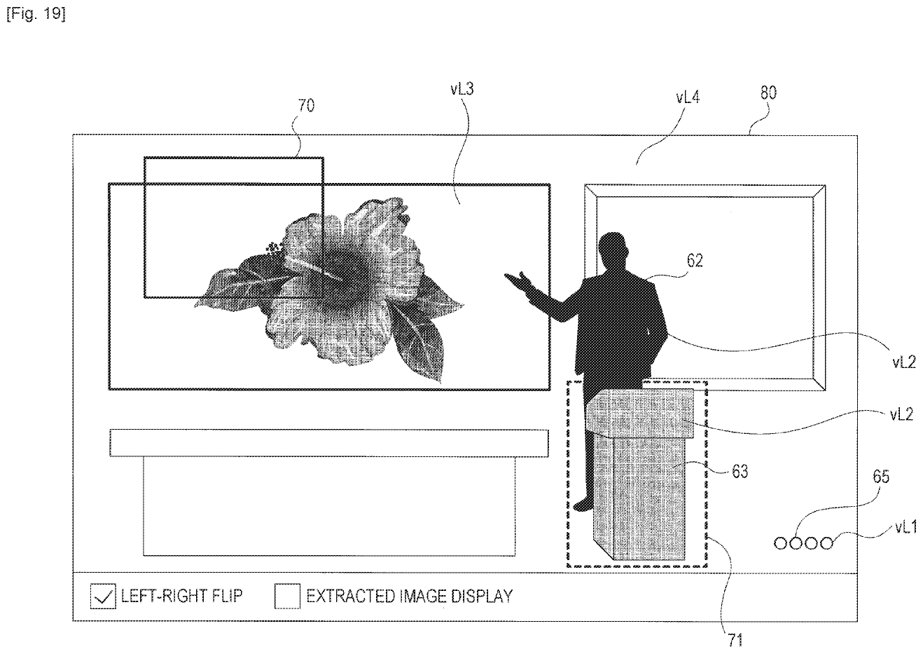

Furthermore, for example, it is assumed that the left-right flip check box 81 is checked by the operation on the confirmation monitor 16. In this case, the image processing apparatus 1 generates, as the output image vOUTm, image data for displaying a left-right flipped image of the synthesized image, as illustrated in FIG. 19, and outputs the image data from the output terminal 7-m. For example, when the confirmation monitor 16 is directed to the performer 62, the performer 62 performs while viewing the left-right flipped image.

In a case where the performer 62 uses the confirmation monitor 16 as a monitor for confirming an action of the performer 62, a displayed video and movement of the performer 62 are left-right reversed if the video is not left-right flipped, and the performer 62 is not able to intuitively act. Therefore, by left-right flipping the video as if the video is reflected in the mirror, the movement of the performer matches the video, and the performer can smoothly move.

Furthermore, the image processing apparatus 1 displays, on the left-right flipped image, the mask frame 70 and the absolute extraction frame 71 so as to indicate the mask area and the absolute extraction area. As a result, the performer 62 can start imaging while confirming not to enter the mask area or not to move items in the absolute extraction area.

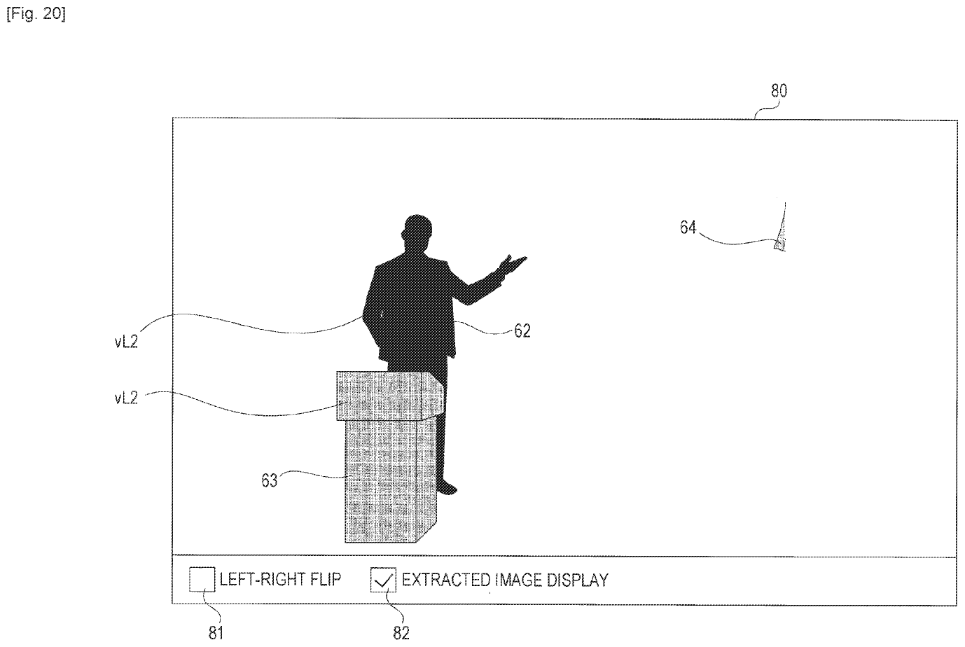

Furthermore, for example, it is assumed that the staff performs an operation to check the extracted image check box 82 by an operation on the confirmation monitor 15 side. In this case, the image processing apparatus 1 generates, as the output image vOUT2, image data for displaying an image of only the extracted image vE (an image of only the second layer image vL2), as illustrated in FIG. 20, and outputs the image data from the output terminal 7-2.

As a result, the staff can easily confirm whether or not the extracted image vE is in an appropriate state. By displaying only the extracted image vE based on the camera image, what kind of image inhibits correct operation can be confirmed when the synthesis is not able to be performed as expected, for example, and the staff can take some measures against a portion with a problem.

For example, FIG. 20 illustrates a state in which a part of the curtain 64 appears in the extracted image vE due to relatively large movement. It can be understood that this is because the range of the mask area was not sufficient. Therefore, the staff can take measures such as resetting the mask area so that such a state does not occur.

<5. Processing Example in Case of Performing Object Recognition>

By the way, in the above processing example, processing of combining object recognition with moving object extraction may be performed.

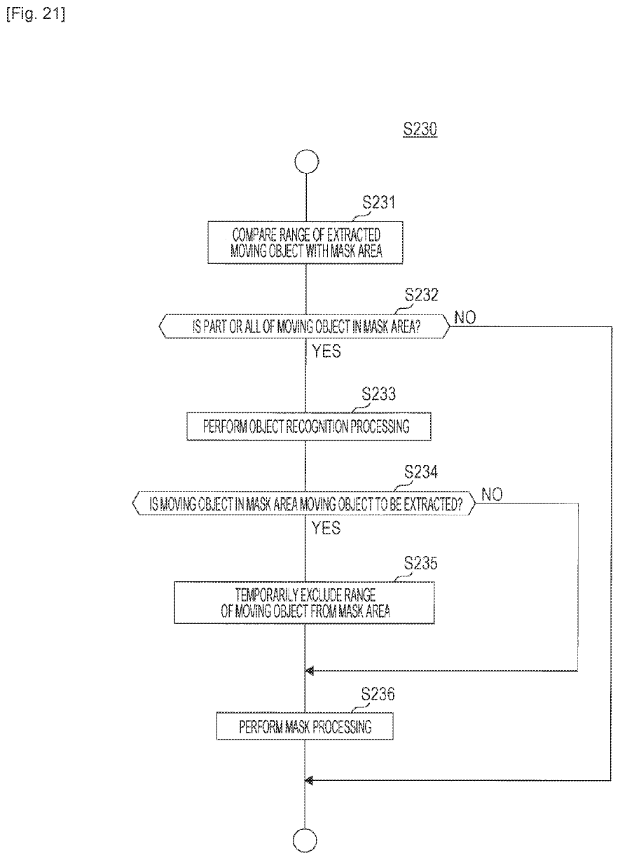

For example, FIG. 21 illustrates a processing example of applying object recognition in the mask processing in step S230 in FIG. 16.

In step S231 in FIG. 21, the image processing apparatus 1 performs processing of comparing a range of the moving object extracted in step S220 in FIG. 16 (a pixel range of the image extracted as the moving object) with the mask area.

In step S232, the image processing apparatus 1 checks whether or not a part or all of the subject extracted as the moving object is in the mask area.

In particular, the image processing apparatus 1 simply terminates the mask processing in a case where there is no image of the extracted moving object in the mask area (proceeding to step S240 in FIG. 16).

In a case where a part or all of the extracted moving object is in the mask area, the image processing apparatus 1 proceeds to step S233 and performs object recognition processing for the moving object image in the mask area. That is, the image processing apparatus 1 performs recognition processing by object type, such as whether or not the subject detected as the moving object is a person or something other than a person. In this case, existing recognition processing such as face recognition processing, posture recognition processing, pupil detection processing, or pattern recognition processing of a specific object may be used. Further, the image processing apparatus 1 may confirm the position per frame of an object recognized in the past using tracking processing.

For example, in a case where the moving object to be extracted is a person (performer 62), it is only necessary to recognize whether or not the moving object is at least a person or something other than a person.

In step S234, the image processing apparatus 1 confirms whether or not the moving body image in the mask area is an image of a moving object (for example, a person) to be extracted. When the moving object image is not a moving object to be extracted, the image processing apparatus 1 proceeds from step S234 to S236 and regularly performs the mask processing. That is, the image processing apparatus 1 performs processing of masking the moving object image in the mask area so as not to be added to the extracted image vE.

On the other hand, in a case where the moving object image in the mask area is a moving object (for example, a person) to be extracted, the image processing apparatus 1 proceeds from step S234 to S235, and temporarily excludes a pixel portion of the moving object from the mask area. Then, the image processing apparatus 1 proceeds to step S236 and performs the mask processing. That is, the image processing apparatus 1 performs the processing of masking the moving object image in the mask area so as not to be added to the extracted image vE but not masking only the moving object portion.

By performing the object recognition using the mask processing as described above, the image of the performer 62 can be avoided from masking even if the performer 62 (for example, the entire body or a part of the body such as a hand of the performer 62) enters the mask area during imaging.

In this case, the object recognition processing increases a processing load, as compared to simple mask processing. However, the object recognition is not performed for the entire image but only for the moving object image extracted in the mask area. Therefore, the increase in processing load is smaller than the case of performing the object recognition for the entire screen.

A case in which the moving object to be extracted enters the mask area has been described. However, conversely, it is also conceivable to perform object recognition for dealing with a case where an object to be masked goes outside the mask area. For example, it is assumed that an object other than the performer 62, such as the curtain 64, is recognized as a result of the object recognition in step S233.

In this case, a pixel portion of an image of the curtain 64 or the like protruding from the mask area is specified, and the pixel portion is also temporarily set to the mask area, and the mask processing is performed. In doing so, even if an object not desired to be extracted moves more than expected and protrudes from the mask area, the object can be appropriately masked so as not to be included in the extracted image vE.

Since this processing is also object recognition processing in a limited range called a mask area, a processing burden may be smaller than that in the case of performing object recognition for the entire screen.

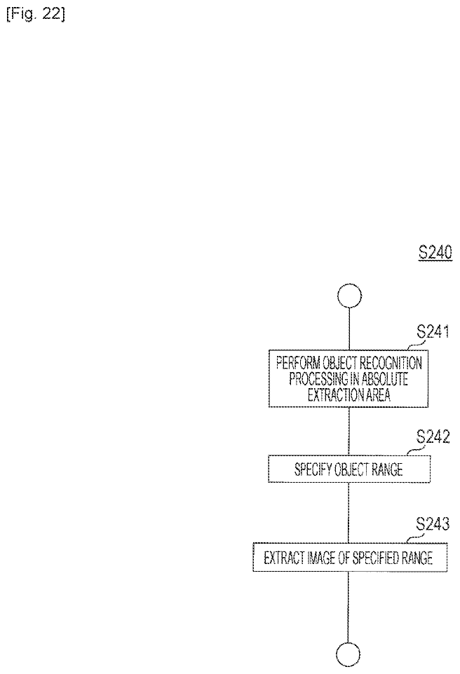

Next, an example of applying object recognition in the absolute extraction area image extraction processing in step S240 in FIG. 16 will be described with reference to FIG. 22.

In step S241, the image processing apparatus 1 performs object recognition processing for a subject in the absolute extraction area. Then, in step S242, the image processing apparatus 1 identifies a main object range (pixel range). For example, the pixel range of the podium 63 is specified.

In step S244, the image processing apparatus 1 performs processing of extracting an image of the specified object range. That is, the image processing apparatus 1 extracts the object in the absolute extraction area as if the object is cut, instead of extracting all of pixels included in the absolute extraction area. For example, the image processing apparatus 1 cuts only the podium 63 and does not cut an image of a periphery other than the podium 63. As a result, even if the absolute extraction area is set somewhat vaguely, an image of an extra item and the like can be prevented from extraction.

Furthermore, in a case where a part of the object to be extracted protrudes from the absolute extraction area, a state of extracting an image with a part of the object missing can be prevented by extracting the object on the basis of an image recognition result.

As described above, the following examples are conceivable regarding the object extraction from the absolute extraction area:
simply extracting all of pixels in the absolute extraction area;
performing object recognition and extracting a pixel portion of the target object in the absolute extraction area (extracting a contour along the recognized object); and
performing object recognition, and extracting pixels of the target object even if a part of the image of the target object protrudes from the absolute extraction area.

<6. Conclusion and Modifications>

In the above embodiment, the following effects can be obtained. The image processing apparatus 1 according to the embodiment includes the moving object extraction unit 20 that generates, regarding the moving object extraction target image (for example, the camera image), the extracted image vE obtained by extracting an image of a moving object in an area other than the mask area set as an area from which an image to be used for synthesis is not extracted, and the image synthesis unit 21 that performs processing of synthesizing the extracted image vE by the moving object extraction unit 20 with another image (see FIG. 16).

The moving object extraction for the moving object image such as the performer 62 can be sufficiently performed even by a device with a general processing capability with a small processing load by simply detecting the moving object by a technique such as frame difference and extracting the image of the range of the moving object (contour portion), for example. However, in the meantime, an object with unnecessary movement such as the curtain 64 in the above example is detected as a moving object and extracted as an image to be synthesized. In the present embodiment, since an area having a subject that is not desired to be extracted as a moving object is not extracted as a moving object image to be synthesized by the mask area, a subject image with unnecessary movement can be prevented from appearing in the synthesized image.

Thereby, a high-quality synthesized image in which only the target moving object such as the performer 62 is appropriately synthesized with, for example, a background image or the like, can be provided.

In the embodiment, the moving object extraction unit 20 includes the image of the absolute extraction area set as an area from which an image to be used for synthesis is extracted in the extracted image vE, as an image to be synthesized by the image synthesis unit 21, regardless of whether or not an object is a moving object (see FIG. 16).

For example, even if there is a subject that is desired to be used for synthesis in the camera image, the subject is not extracted due to a stationary object, and therefore a desired image may not be able to be produced. Meanwhile, the example of the embodiment sets the absolute extraction area, whereby the image of the podium 63 appears in the synthesized image although the podium 63 is not a moving object, for example.

That is, the stationary object such as the podium 63 is not extracted in simple moving object extraction, but an image desired to be extracted can be extracted even if the object is not a moving object by setting the absolute extraction area. Therefore, the image producer can easily produce a more desired synthesized image.

An example in which the image processing apparatus 1 according to the embodiment includes the UI control unit 23 that controls the setting of the position, shape, or size of the mask area on the screen has been described (see FIGS. 12, 13, 14, and 15).

For example, the setting screen 50 is provided so that the user can determine the position of the mask area or can determine the shape and size of the mask area by an operation on the screen on which the moving object extraction target image and another image are displayed. Thereby, the mask area can be set at an arbitrary position on an image. Furthermore, as the shape of the mask area, a square or a rectangle, and the size thereof can be arbitrarily set.

Note that the shape of the mask area is not limited to a square or a rectangle, and can be arbitrarily set to various shapes such as a triangle, a polygon of pentagon or more, a circle, an ellipse, an indefinite shape, and a shape along a contour of an object.

In the embodiment, the UI control unit 23 controls the setting of the position, shape, or size of the mask area on the screen on which the synthesized image of the camera image as the moving object extraction target image and another image (the background image, for example) is displayed (see FIGS. 13 and 14).

Thereby, the mask area can be set to a range desired by the user in accordance with subject layout limitation or performer position limitation of the input image supplied from the camera or a synthesized image production policy such as selection of an object not desired to be synthesized, for example. In particular, since the user can set the mask area while confirming an object or the like in the synthesized image, appropriate position, shape, and size as the mask area can be easily set.

Furthermore, since the mask area that can be ignored even if a moving object other than the subject exists in the image can be easily set, the image quality can be improved and the degree of freedom of camera installation becomes high, and preparation for imaging becomes simple.

In the embodiment, an example in which the UI control unit 23 controls the setting of the position, shape, or size of the absolute extraction area on the screen has been described (see FIGS. 12, 13, 14, and 15).

For example, the user can determine the position of the absolute extraction area or can determine the shape or size of the absolute extraction area by an operation on the screen on which the moving object extraction target image and the another image are displayed.

Thereby, the absolute extraction area can be set at an arbitrary position on the image. Furthermore, as the shape of the absolute extraction area, a square or a rectangle, and the size thereof can be arbitrarily set.

Note that the shape of the absolute extraction area is not limited to a square or a rectangle, and it is conceivable that the shape can be arbitrarily set to various shapes such as a triangle, a polygon of pentagon or more, a circle, an ellipse, an indefinite shape, and a shape along a contour of an object.

By easily setting an area in which the input image is necessarily used, as the absolute extraction area, the degree of freedom of expression is increased, and an idea of the capturer can be easily realized.

In the embodiment, the UI control unit 23 controls the setting of the position, shape, or size of the absolute extraction area on the screen on which the synthesized image of the moving object extraction target image and another image is displayed (see FIGS. 13 and 14). Thereby, the absolute extraction area can be set to a range desired by the user in accordance with subject layout limitation or performer position limitation of the input image supplied from the camera or a synthesized image production policy such as selection of an object to be synthesized, for example. In particular, since the user can set the absolute extraction area while confirming an object or the like in the synthesized image, appropriate position, shape, and size as the absolute extraction area can be easily set.

Thereby, preparation for imaging a desired image can be easily performed.

In the embodiment, an example in which the UI control unit 23 varies the image synthesis ratio according to the operation in the synthesized image of the camera image as the moving object extraction target image and another image (the background image, for example) has been described (see FIGS. 12, 13, and 14). In the synthesized image displayed for setting the mask area, the synthesis ratio of the camera image can be varied by the operation of the transmittance adjustment bar 54 by the user with respect to the background image, for example. For example, a display state in which the camera image clearly appears, lightly appears, or disappears can be varied.

Therefore, the user can confirm a subject position by converting the transmittance (synthesis ratio) of the camera image with respect to the background image. As a result, the user can perform an operation to set the mask area and the absolute extraction area on the background image in a favorable synthesis ratio state.

By changing the transmittance of the camera image on the background image, the mask area and the absolute extraction area can be easily set to convenient locations while considering the background.

Meanwhile, it is also conceivable to variably set the synthesis ratios of the background image and the screen image after displaying the camera image on a constant basis. Thereby, the mask area and the absolute extraction area can be set in a state where the camera image can be easily confirmed in a case of a rehearsal situation including the performer.

An example in which the UI control unit 23 of the embodiment makes the display indicating the mask area on the screen and the display indicating the absolute extraction area on the screen be in different display modes has been described.

That is, the UI control unit 23 makes the display modes of the mask frame 70 and the absolute extraction frame 71 different when displaying the mask area and the absolute extraction area on the screen to present the ranges of the mask area and the absolute extraction. For example, the color of the frame range, the type of the frame line (solid line, broken line, wavy line, double line, thick line, thin line, or the like), the brightness, the transparency in the frame, or the like is made different.

Thereby, the user can clearly identify the mask frame and the absolute extraction frame, and can appropriately set the range not desired to be extracted and the range desired to be extracted even if an object is not a moving object.

In the embodiment, the UI control unit 23 performing the processing of limiting the setting operation so as not to cause an overlap of the mask area and the absolute extraction area has been described. For example, the mask area and the absolute extraction area can be arbitrarily set by being displayed with the mask frame 70 and the absolute extraction frame 71 on the screen. However, such an operation is limited in a case where an overlap occurs by the operation (step S136 in FIG. 6 and step S146 in FIG. 7).

If the mask area and the absolute extraction area overlap, the mask processing and the absolute extraction processing may not be able to be appropriately executed. Therefore, in a case where an overlap occurs due to the user's operation, the limitation is set to a range where no overlap occurs. Thus, even when the user is not particularly conscious, an overlap can be prevented.

In the embodiment, the UI control unit 23 controls the setting of another image to be synthesized with the camera image. In the above example, the UI control unit 23 synthesizes other images such as the background image as the bottom layer image vL4, the screen image as the third layer image vL3, and the logo image as the top layer image vL1 with the extracted image vE from the camera image, which is used as the second layer image vL2. These other images can be selected on the setting screen 50. As a result, the user who is the image producer can create an arbitrary image.

In the embodiment, the image synthesis unit 21 can output the synthesized image of the extracted image vE by the moving object extraction unit 20 and the other images and can output a left-right flipped image of the synthesized image (see FIG. 19).

In the left-right flipped image, the left-right direction recognized by the performer 62 matches the left-right direction displayed on the monitor screen. Therefore, an appropriate image can be provided as a monitor image confirmed by the performer 62 while he/she performs.

In the embodiment, the image synthesis unit 21 can output the synthesized image of the extracted image vE by the moving object extraction unit 20 and the other images and can output only the extracted image vE extracted by the moving object extraction unit 20 (see FIG. 20).

By displaying and outputting the extracted image vE, the staff who is checking the confirmation monitor 15 can easily confirm whether or not appropriate moving object extraction is being performed and can also take appropriate measures, for example.

The UI control unit 23 of the embodiment controls an output of the left-right flipped image of the synthesized image on the output monitor screen 80 (see FIG. 19).

The user can display the left-right flipped image on the confirmation monitor 16 or the like using the left-right flip check box 81 depending to a situation. For example, the user can flexibly respond to a request by the performer 62 or the like.

The UI control unit 23 of the embodiment controls an output of the extracted image vE by the moving object extraction unit on the output monitor screen 80 (see FIG. 20).

The user can display only the image extracted by the moving object extraction unit 20 on the confirmation monitor 15 or the like, for example, using the extracted image check box 82 depending to a situation. For example, the user can confirm only the image extracted by the moving object extraction unit 20 as necessary while usually checking the synthesized image on the confirmation monitor 15.

In the embodiment, the moving object extraction target image is a captured image by the camera 11.

Therefore, in the captured image, not extracting an object with movement in the mask area while extracting a moving object such as the performer 62, or extracting an object without movement in the absolute extraction area can be appropriately performed, and an appropriate operation is realized in a case of synthesizing the captured image with the background image or the like.

In the embodiment, one of the other images synthesized with the camera image is the background image.

Therefore, in a case of producing a video in which the moving object such as the performer 62 performs in a desired background, exclusion of unnecessary objects and extraction of non-moving objects desired to be synthesized become possible.

In the embodiment, images of a plurality of systems can be input to the image processing apparatus 1, the moving object extraction target image is a captured image by the camera 11 input in one system, and one of the other images is an input image input from the PC 12 or the like input in another system. An example of preparing the screen area 61 on the background and synthesizing the screen image using the image supplied from the PC 12 as the third layer image vL3 has been described. As a result, an image that the performer 62 uses for description, performance, presentation, or the like is prepared and the prepared image can be a target to be synthesized.

In the embodiment, one of the other images synthesized with the camera image is the logo image.

As a result, the synthesized image in which the image right holder, the producer, and the like are clarified can be easily produced.

Note that, in the embodiment, both the mask area and the absolute extraction area have been settable. However, only the mask area may be settable or only the absolute extraction area may be settable. Naturally, as the synthesis processing illustrated in FIG. 16, either step S230 or S240 may be performed according to the setting.

The program of the embodiment is a program for causing a CPU, a DSP, or a device including the CPU and the DSP, for example, to execute the processing in FIGS. 5, 6, and 7, the processing in FIG. 16, or the processing in FIGS. 21, 22, and the like as a modification of the aforementioned processing.

That is, the program of the embodiment is a program for causing the image processing apparatus to execute processing of generating, regarding the moving object extraction target image, the extracted image vE obtained by extracting an image of a moving object in an area other than the mask area set as an area from which an image to be used for synthesis is not extracted, and processing of synthesizing the extracted image vE with another image.

With such a program, the above-described image processing apparatus can be realized in devices such as an information processing apparatus, a portable terminal device, an image editing device, a switcher, and an imaging device.

Such a program can be recorded in advance in an HDD as a recording medium built in a device such as a computer device, a ROM in a microcomputer having a CPU, or the like.

Alternatively, the program can be temporarily or permanently stored (recorded) on a removable recording medium such as a flexible disk, a compact disc read only memory (CD-ROM), a magneto optical (MO) disk, a digital versatile disc (DVD), a Bu-ray Disc (registered trademark), a magnetic disk, a semiconductor memory, or a memory card. Such a removable recording medium can be provided as so-called package software. Furthermore, such a program can be installed from a removable recording medium to a personal computer or the like, and can also be downloaded from a download site via a network such as a local area network (LAN) or the Internet.

Furthermore, such a program is suitable for providing a wide range of image processing apparatuses according to the embodiment. For example, by downloading a program to a personal computer, a portable information processing apparatus such as a smartphone or a tablet device, a mobile phone, a game device, a video device, a personal digital assistant (PDA), or the like, the personal computer or the like can be caused to function as the image processing apparatus according to the present disclosure.

Note that the effects described in the present specification are merely examples and are not limited, and other effects may be exhibited.

Note that the present technology can also have the following configurations.

(1)

An image processing apparatus including:

a moving object extraction unit configured to generate, regarding a moving object extraction target image, an extracted image obtained by extracting an image of a moving object in an area other than a mask area set as an area from which an image to be used for synthesis is not extracted; and

an image synthesis unit configured to perform processing of synthesizing the extracted image with another image. (2)

The image processing apparatus according to (1), in which the moving object extraction unit extracts an image of an absolute extraction area set as an area from which an image to be used for synthesis is extracted, from the moving object extraction target image, regardless of whether or not an object is a moving object, and generates the extracted image.

(3)

The image processing apparatus according to (1) or (2), further including:

a user interface control unit configured to control a setting of a position, a shape, or a size of the mask area on a screen. (4)

The image processing apparatus according to (3), in which the user interface control unit controls the setting of a position, a shape, or a size of the mask area on a screen on which a synthesized image of the moving object extraction target image and the another image is displayed.

(5)

The image processing apparatus according to (2), further including:

a user interface control unit configured to control a setting of a position, a shape, or a size of the absolute extraction area on a screen.

(6)

The image processing apparatus according to (5), in which the user interface control unit controls the setting of a position, a shape, or a size of the absolute extraction area on a screen on which a synthesized image of the moving object extraction target image and the another image is displayed.

(7)

The image processing apparatus according to (4) or (6), in which the user interface control unit varies an image synthesis ratio according to an operation on the synthesized image of the moving object extraction target image and the another image.

(8)

The image processing apparatus according to any one of (2), (5), and (6), further including:

a user interface control unit configured to control a setting of a position, a shape, or a size of one or both of the mask area and the absolute extraction area on a screen, in which the user interface control unit makes a display indicating the mask area on the screen and a display indicating the absolute extraction area on the screen be in different display modes.

(9)

The image processing apparatus according to any one of (2), (5), and (6), further including:

a user interface control unit configured to control a setting of a position, a shape, or a size of one or both of the mask area and the absolute extraction area on a screen, in which the user interface control unit performs processing of limiting a setting operation so as not to cause an overlap of the mask area and the absolute extraction area.

(10)

The image processing apparatus according to any one of (3) to (9), in which

the user interface control unit controls a setting of the another image.

(11)

The image processing apparatus according to any one of (1) to (10), in which

the image synthesis unit is able to output a synthesized image of the extracted image and the another image and also output a left-right flipped image of the synthesized image.

(12)

The image processing apparatus according to any one of (1) to (11), in which

the image synthesis unit is able to output a synthesized image of the extracted image and the another image and also output the extracted image.

(13)

The image processing apparatus according to (11), further including:

a user interface control unit configured to control the output of the left-right flipped image of the synthesized image.

(14)

The image processing apparatus according to (12), further including:

a user interface control unit configured to control the output of the extracted image.

(15)

The image processing apparatus according to any one of (1) to (14), in which

the moving object extraction target image is a captured image by a camera.

(16)

The image processing apparatus according to any one of (1) to (15), in which

one of the other images is a background image.

(17)

The image processing apparatus according to any one of (1) to (16), in which

images of a plurality of systems are able to be input, the moving object extraction target image is a captured image by a camera input in one system, and

one of the other images is an input image input in another system.

(18)

The image processing apparatus according to any one of (1) to (15), in which

one of the other images is a logo image.

(19)

An image processing method including:

generating, regarding a moving object extraction target image, an extracted image obtained by extracting an image of a moving object in an area other than a mask area set as an area from which an image to be used for synthesis is not extracted; and

performing processing of synthesizing the extracted image with another image.

(20)

A program for causing an image processing apparatus to execute:

processing of generating, regarding a moving object extraction target image, an extracted image obtained by extracting an image of a moving object in an area other than a mask area set as an area from which an image to be used for synthesis is not extracted; and

processing of synthesizing the extracted image with another image.

It should be understood by those skilled in the art that various modifications, combinations, sub-combinations and alterations may occur depending on design requirements and other factors insofar as they are within the scope of the appended claims or the equivalents thereof.

### REFERENCE SIGNS LIST

1 mage processing apparatus

2 CPU

3 GPU

4 Flash ROM

5 RAM

6, 6-1, 6-2, 6-n Input terminal

7, 7-1, 7-2, 7-m Output terminal

8 Network communication unit

20 Moving object extraction unit

21 Image synthesis unit

22 Setting unit

23 UI control unit

50 Setting screen

54 Transmittance adjustment bar

55 Preview area

62 Performer

63 Podium

64 Curtain

65 Logo

70 Mask frame

71 Absolute extraction frame

1. An image processing apparatus comprising:
a moving object extraction unit configured to generate, regarding a moving object extraction target image, an extracted image obtained by extracting an image of a moving object in an area other than a mask area set as an area from which an image to be used for synthesis is not extracted; and
an image synthesis unit configured to perform processing of synthesizing the extracted image with another image.

2. The image processing apparatus according to claim 1, wherein
the moving object extraction unit extracts an image of an absolute extraction area set as an area from which an image to be used for synthesis is extracted, from the moving object extraction target image, regardless of whether or not an object is a moving object, and generates the extracted image.

3. The image processing apparatus according to claim 1, further comprising:
a user interface control unit configured to control a setting of a position, a shape, or a size of the mask area on a screen.

4. The image processing apparatus according to claim 3, wherein
the user interface control unit controls the setting of a position, a shape, or a size of the mask area on a screen on which a synthesized image of the moving object extraction target image and the another image is displayed.

5. The image processing apparatus according to claim 2, further comprising:
a user interface control unit configured to control a setting of a position, a shape, or a size of the absolute extraction area on a screen.

6. The image processing apparatus according to claim 5, wherein
the user interface control unit controls the setting of a position, a shape, or a size of the absolute extraction area on a screen on which a synthesized image of the moving object extraction target image and the another image is displayed.

7. The image processing apparatus according to claim 4, wherein
the user interface control unit varies an image synthesis ratio according to an operation on the synthesized image of the moving object extraction target image and the another image.

8. The image processing apparatus according to claim 2, further comprising:
a user interface control unit configured to control a setting of a position, a shape, or a size of one or both of the mask area and the absolute extraction area on a screen, wherein
the user interface control unit makes a display indicating the mask area on the screen and a display indicating the absolute extraction area on the screen be in different display modes.

9. The image processing apparatus according to claim 2, further comprising:
a user interface control unit configured to control a setting of a position, a shape, or a size of one or both of the mask area and the absolute extraction area on a screen, wherein
the user interface control unit performs processing of limiting a setting operation so as not to cause an overlap of the mask area and the absolute extraction area.

10. The image processing apparatus according to claim 3, wherein
the user interface control unit controls a setting of the another image.

11. The image processing apparatus according to claim 1, wherein
the image synthesis unit is able to output a synthesized image of the extracted image and the another image and also output a left-right flipped image of the synthesized image.

12. The image processing apparatus according to claim 1, wherein
the image synthesis unit is able to output a synthesized image of the extracted image and the another image and also output the extracted image.

13. The image processing apparatus according to claim 11, further comprising:
a user interface control unit configured to control the output of the left-right flipped image of the synthesized image.

14. The image processing apparatus according to claim 12, further comprising:
a user interface control unit configured to control the output of the extracted image.

15. The image processing apparatus according to claim 1, wherein
the moving object extraction target image is a captured image by a camera.

16. The image processing apparatus according to claim 1, wherein
one of the other images is a background image.

17. The image processing apparatus according to claim 1, wherein
images of a plurality of systems are able to be input,
the moving object extraction target image is a captured image by a camera input in one system, and
one of the other images is an input image input in another system.

18. The image processing apparatus according to claim 1, wherein
one of the other images is a logo image.

19. An image processing method comprising:
generating, regarding a moving object extraction target image, an extracted image obtained by extracting an image of a moving object in an area other than a mask area set as an area from which an image to be used for synthesis is not extracted; and
performing processing of synthesizing the extracted image with another image.

20. A program for causing an image processing apparatus to execute:
processing of generating, regarding a moving object extraction target image, an extracted image obtained by extracting an image of a moving object in an area other than a mask area set as an area from which an image to be used for synthesis is not extracted; and
processing of synthesizing the extracted image with another image.
